(19) United States
(12) Patent Application Publication
(10) Pub. No.: US 2026/0172827 A1
(43) Pub. Date: Jun. 18, 2026

(54) Intelligent Setup for Playback Devices

(71) Applicant: Sonos, Inc., Goleta, CA (US)

(72) Inventors: Jennifer McDevitt, Santa Barbara, CA (US); James Babu, Seattle, WA (US); Patrick Celentano, Boston, MA (US); Kyle Hutchings, Fuquay-Varina, NC (US); Pratik Bhangale, Seattle, WA (US); Michael Agerbak, Cambridge, MA (US); Daniel Valente, Dracut, MA (US); William Shoesmith, Arlington, MA (US); Derek W. Erdmann, Duvall, WA (US); Conor Walsh, Natick, MA (US); Nikolai Kutateli, Santa Barbara, CA (US); Carl Fristrom, Watertown, MA (US); Youngjoo Park, Bellevue, WA (US)

(21) Appl. No.: 19/534,341

(22) Filed: Feb. 9, 2026

Related U.S. Application Data
(63) Continuation of application No. 17/485,252, filed on Sep. 24, 2021, now Pat. No. 12,549,945.
(60) Provisional application No. 63/083,637, filed on Sep. 25, 2020.

(51) Int. Cl. H04W 12/06; G06F 3/16; H04W 4/08; H04W 4/80; H04W 12/63; H04W 76/14

(52) U.S. Cl. CPC H04W 12/068; H04W 4/08; H04W 12/63; H04W 76/14; G06F 3/167; H04W 4/80

(57) ABSTRACT

A computing device configured to (i) receive a set of messages from a playback device indicating the playback device's setup availability and network connection capability, (ii) establish a direct communication path with the playback device, (iii) receive, outside the direct communication path, authentication information from the playback device, (iv) after receiving, outside the direct communication path, the authentication information from the playback device, receive, from the playback device, and transmit, to the playback device, the authentication information via the direct communication path, (v) after receiving and transmitting the authentication information via the direct communication path, transmit, to the playback device over the direct communication path, configuration parameters for connecting to a secure wireless network, (vi) after transmitting the configuration parameters, detect an indication that the playback device has successfully received the configuration parameters, and (vii) after the detection, transition to communicating with the playback device over the secure wireless network.

### CROSS-REFERENCE TO RELATED APPLICATIONS

This application claims the benefit of priority as a continuation under 35 U.S.C. § 120 to U.S. application Ser. No. 17/485,252, filed Sep. 24, 2021, and titled “Intelligent Setup for Playback Devices,” which claims the benefit of priority under 35 U.S.C. § 119 to U.S. Provisional Patent App. No. 63/083,637, filed on Sep. 25, 2020, which is incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

Given the ever-growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of an example playback device.

FIG. 1D is a block diagram of an example playback device.

FIG. 1E is a block diagram of an example playback device.

FIG. 1F is a block diagram of an example network microphone device.

FIG. 1G is a block diagram of an example playback device.

FIG. 1H is a partially schematic diagram of an example control device.

FIG. 1I is a schematic diagram of example user interfaces of the example control device of FIG. 1H.

FIGS. 1J through 1M are schematic diagrams of example corresponding media playback system zones.

FIG. 2 is a schematic diagram of example media playback system areas.

FIG. 3 is an isometric diagram of an example playback device housing.

FIG. 4 is a diagram of an example headset assembly for the playback device of FIG. 3.

FIG. 5 is a flowchart showing example operations for intelligent setup of a playback device.

FIG. 6 shows an example notification on a control device of a new playback device that is available for setup.

FIG. 7A shows an example instruction on a control device to scan an NFC tag on a playback device.

FIG. 7B shows another example instruction on a control device to scan an NFC tag on a playback device

FIG. 8 shows an example instruction on a control device to hold the control device near a playback device playing an audible tone.

FIG. 9 shows an example instruction on a control device to manually enter a PIN code.

FIG. 10A shows an example instruction on a control device to press a button on a playback device.

FIG. 10B shows another example instruction on a control device to press a button on a playback device.

FIG. 11 shows an example indication on a control device to select a room name for a playback device.

FIG. 12A shows an example indication on a control device to begin a setup process to join playback devices as members of a bonded group.

FIG. 12B shows another example indication on a control device to begin a setup process to join playback devices as members of a bonded group.

FIG. 12C shows another example indication on a control device to begin a setup process to join playback devices as members of a bonded group.

FIG. 12D shows another example indication on a control device to begin a setup process to join playback devices as members of a bonded group.

FIG. 12E shows an example indication on a control device to confirm an update to playback device's location in a media playback system.

FIG. 13A shows an example instruction on a control device to move to a given location and select a playback device playing an audible tone.

FIG. 13B shows another example instruction on a control device to move to a given location and select a playback device playing an audible tone

FIG. 14A shows an example notification on a control device regarding voice assistant services.

FIG. 14B shows another example notification on a control device regarding voice assistant services.

FIG. 15 shows an example notification on a control device of a problem detected with a playback device in a bonded group.

FIG. 16A shows an example instruction on a control device to remove one or more playback devices from a bonded group

FIG. 16B shows another example instruction on a control device to remove one or more playback devices from a bonded group.

FIG. 16C shows another example instruction on a control device to remove one or more playback devices from a bonded group.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Since its earliest days, Sonos, Inc. (“Sonos”) has been an innovator in the area of device setup experiences. In 2005, Sonos filed U.S. application Ser. No. 11/147,116, which describes techniques for automatically configuring necessary parameters of a device (e.g., a playback device) to be coupled to a network with minimum human intervention. These techniques involved using another device (e.g., a controller device) to establish a rudimentary communication path with the device to exchange the necessary parameters for the device to function properly in the network. U.S. application Ser. No. 11/147,116, filed Jun. 6, 2006, titled “Establishing a secure wireless network with minimum human intervention,” and issued as U.S. Pat. No. 8,326,951, is incorporated by reference herein in its entirety. Additional concepts beyond those specifically discussed above are disclosed in U.S. application Ser. No. 11/147,116.

In 2011, Sonos filed U.S. application Ser. No. 13/340,110, which describes techniques for a wireless device (e.g., smartphone) to identify and monitor one or more available networks for connection to a multimedia playback network. The wireless device may evaluate a network characteristic (e.g., signal strength) of the one or more available networks to identify a preferred network for connection, and facilitate a switch of the wireless device's connection if it is not using the preferred network. U.S. application Ser. No. 13/340,110, filed Dec. 29, 2011, titled “Systems and methods for multi-network audio control,” and issued as U.S. Pat. No. 9,247,492, is incorporated by reference herein in its entirety. Additional concepts beyond those specifically discussed above are disclosed in U.S. application Ser. No. 13/340,110.

Sonos further discussed connection of a wireless device in U.S. application Ser. No. 13/340,116, which describes techniques for allowing a user to connect a wireless device (e.g., smartphone) to a hidden network without the wireless device or the user knowing or typing in the network name. U.S. application Ser. No. 13/340,116, filed Dec. 29, 2011, titled “Systems and methods for connecting an audio controller to a hidden audio network,” and issued as U.S. Pat. No. 9,191,699, is incorporated by reference herein in its entirety. Additional concepts beyond those specifically discussed above are disclosed in U.S. application Ser. No. 13/340,116.

In U.S. application Ser. No. 13/341,245, Sonos described techniques for configuration and naming of a multimedia playback device on a local playback network, including configuration and naming based on analysis of one or more playback devices that are already connected to the network. U.S. application Ser. No. 13/341,245, filed Dec. 30, 2011, titled “Systems and methods for player setup room names,” and issued as U.S. Pat. No. 9,344,292, is incorporated by reference herein in its entirety. Additional concepts beyond those specifically discussed above are disclosed in U.S. application Ser. No. 13/341,245.

In U.S. application Ser. No. 13/568,993, Sonos described techniques whereby a playback device may transmit an acoustic signature (e.g., outside the audible range of the human ear) that may be automatically detected by another device (e.g., a smartphone). The acoustic signature may be used to determine that the smartphone is in the vicinity of the playback device. U.S. application Ser. No. 13/568,993, filed Aug. 7, 2012, titled “Acoustic signatures in a playback system,” and issued as U.S. Pat. No. 8,930,005, is incorporated by reference herein in its entirety. Additional concepts beyond those specifically discussed above are disclosed in U.S. application Ser. No. 13/568,993.

In U.S. application Ser. No. 13/767,843, Sonos further discussed adding a playback device to a secure media playback network. The playback device may, without user input, exchange messages with a device already on the network and thereby receive security parameters for connecting to the secure network. U.S. application Ser. No. 13/767,843, filed Feb. 14, 2013, titled “Automatic configuration of household playback devices,” and issued as U.S. Pat. No. 9,319,409, is incorporated by reference herein in its entirety. Additional concepts beyond those specifically discussed above are disclosed in U.S. application Ser. No. 13/767,843.

In U.S. application Ser. No. 13/767,850, Sonos further discussed adding a playback device to a secure media playback network. A device already connected to the network may receive, from a remote device (e.g., a cloud-based device), a configuration table indicating setup information for the playback device that is to be set up, and may provide the setup information to the playback device, causing it to be configured accordingly. U.S. application Ser. No. 13/767,850, filed Feb. 14, 2013, titled “Automatic configuration of household playback devices,” and issued as U.S. Pat. No. 9,237,384, is incorporated by reference herein in its entirety. Additional concepts beyond those specifically discussed above are disclosed in U.S. application Ser. No. 13/767,850.

In U.S. application Ser. No. 14/988,524, Sonos further discussed adding a playback device to a secure media playback network. A playback device that is available to join a media playback system may receive an instruction to emit a sound, which may allow a user to identify and confirm the playback device that is being set up. U.S. application Ser. No. 14/988,524, filed Jan. 5, 2016, titled “Multiple-device setup,” and issued as U.S. Pat. No. 10,303,422, is incorporated by reference herein in its entirety. Additional concepts beyond those specifically discussed above are disclosed in U.S. application Ser. No. 14/988,524.

In U.S. application Ser. No. 14/988,534, Sonos further discussed adding a playback device to a secure media playback network. During a setup process, a given device (e.g., a smartphone) may identify that the playback device and one or more other playback devices that are already connected to the media playback network are compatible with one or more bonded zone configurations. Compatible bonded zone configurations may then be presented to a user for selection during the setup process. U.S. application Ser. No. 14/988,534, filed Jan. 5, 2016, titled “Intelligent group identification,” and issued as U.S. Pat. No. 10,284,980, is incorporated by reference herein in its entirety. Additional concepts beyond those specifically discussed above are disclosed in U.S. application Ser. No. 14/988,534.

In addition to the non-limiting examples above, numerous other issued patents and pending patent applications reflect Sonos's history of innovation in the area of device setup experiences.

Since Sonos began offering its first networked playback devices for sale in 2005, many other types of network-connected consumer devices, sometimes referred to as “smart home” devices, or more generally, Internet-of-Things (IoT) devices, have become increasingly common. However, as a given ecosystem of products matures over time, providing a cohesive user experience across various models and versions of such products may start to become a challenge. In particular, one of the most fundamental capabilities of a connected device, especially a wireless device, is its ability to establish a connection to the network on which it will operate, typically a user's home Wi-Fi network. While a relatively older device may have one set of networking capabilities based on its hardware, a relatively newer device may have a different set of improved networking capabilities based its newer hardware. However, expecting consumers to replace their older devices in favor of newer versions or “next generation” models each time there are iterative improvements to the devices can lead to substantial user frustration. Therefore, maintaining support for various classes of older devices for as long as possible is preferred.

Nonetheless, as another challenge, the wireless setup of a connected device is often carried out by way of a user device (e.g., a smartphone) that makes an initial connection to the device in order to provide the device with the user's Wi-Fi credentials. In this regard, the user device may be the source of still further variation, as different user devices may have their own different hardware and networking capabilities and may run different operating systems.

For example, the Sonos ecosystem currently includes dozens of playback device models and/or versions, many of which have different hardware and network connection capabilities. Further, even among playback devices of the same model, some devices may have received software updates (e.g., firmware updates) that others have not, which may result in further differences in playback device behavior. Additionally, an even wider range of user devices, which may be operating on one of two different operating systems, may be used to set up a given Sonos playback device. Consequently, a very large number of different setup possibilities must be supported.

Moreover, the variables to be considered when setting up a given device are not limited to those involving networking hardware and firmware versions. As the capabilities of connected devices increase to include new and improved features, various additional setup options for a given device may become available to a user. For instance, an example playback device that is being set up to operate as part of a media playback system as discussed herein may support one or more features such as (i) linking with one or more of the user's media service provider accounts, (ii) integration into a multi-channel home theater setup, (iii) advanced audio calibration techniques, and (iv) incorporation of one or more voice-assistant services, among numerous other features that may exist now or be developed in the future. Each of these features may require a user to complete some degree of additional set up.

As a result, a setup process that supports all of these variables, as well as others, may become overly complicated and cumbersome, and may run the risk of presenting a user with instructions or choices that are not necessary for the user's particular setup situation, or are otherwise not relevant to the user. This may negatively affect the user's experience by obscuring other, more important portions of the device setup, and may lead to decreased user confidence in navigating the setup experience. This, in turn, may lead to more setup mistakes.

For these reasons and others, it can be a substantial challenge to implement an initial setup procedure that can be applied across a system of devices with differing capabilities, and yet remains both simple and engaging such that users are able to navigate device setup confidently and correctly.

Accordingly, embodiments described herein relate to techniques for setting up a playback device for operation on a given data network, which may generally involve enabling the playback device to connect to the given data network, as well as adding the playback device as a member of a media playback system of networked playback devices, some of which may already be connected to the given data network. The techniques may be flexibly and intelligently applied to set up numerous different types of playback devices having a wide range of hardware and software capabilities, all while maintaining an efficient user experience that is easy to navigate and reduces the likelihood of user frustration in the setup process.

Although the example network environments, connected devices, and setup processes discussed herein are generally focused on media playback devices and their associated features, it should be understood that the intelligent setup techniques presented here may also be implemented to address similar problems in other systems of networked devices, IoT devices, smart home devices, etc. Indeed, many of the same benefits such as supporting a broad range of product configurations and extending product lifespans are equally applicable in numerous other types of systems.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

### II. Suitable Operating Environment

a. Suitable Media Playback System

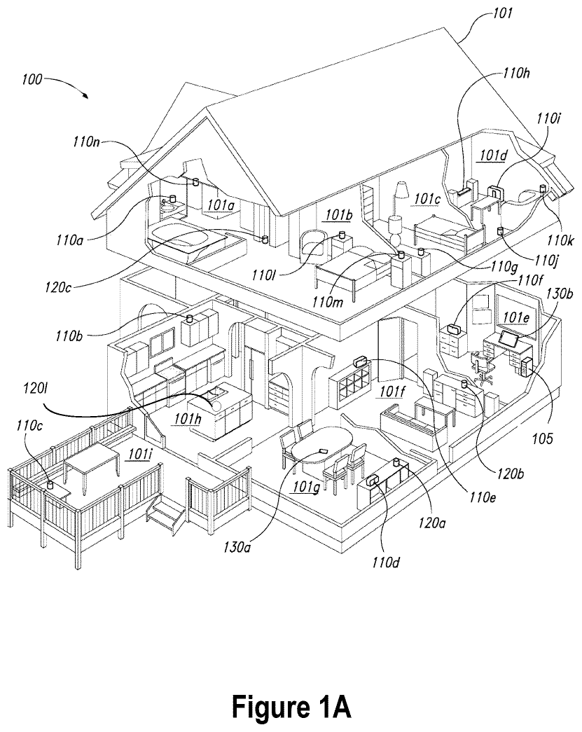

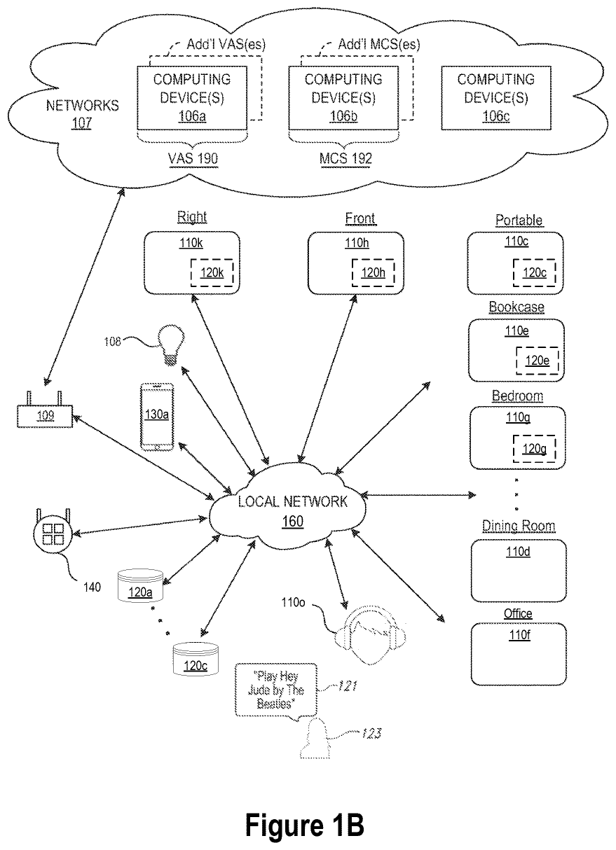

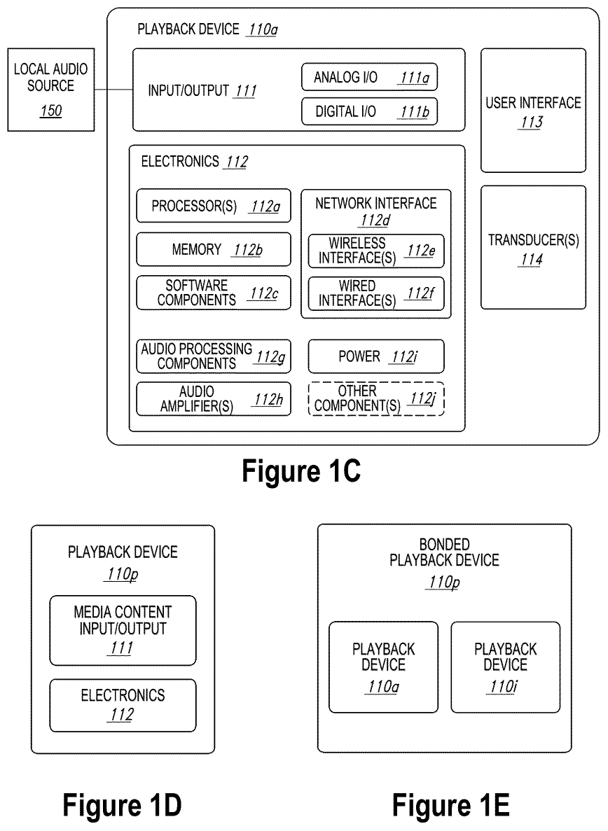

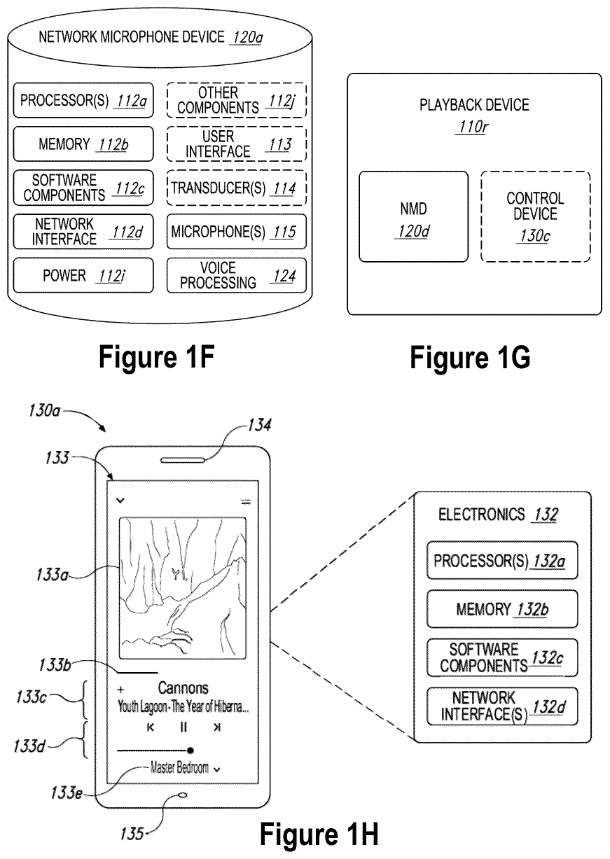

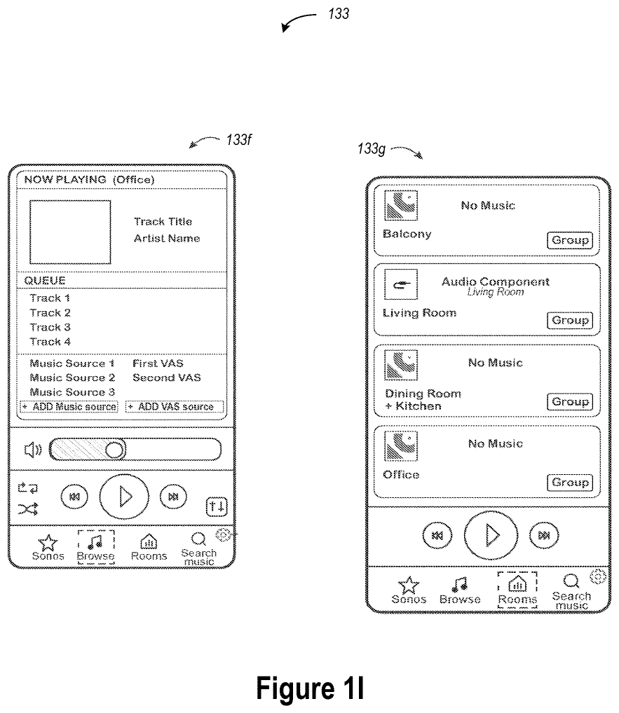

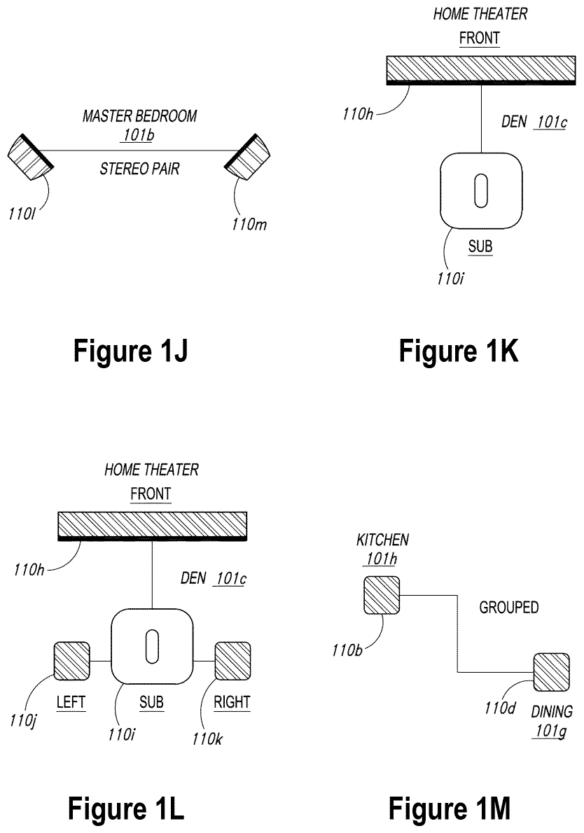

FIGS. 1A and 1B illustrate an example configuration of a media playback system (“MPS”) 100 in which one or more embodiments disclosed herein may be implemented. Referring first to FIG. 1A, a partial cutaway view of MPS 100 distributed in an environment 101 (e.g., a house) is shown. The MPS 100 as shown is associated with an example home environment having a plurality of rooms and spaces. The MPS 100 comprises one or more playback devices 110 (identified individually as playback devices 110a-o), one or more network microphone devices (“NMDs”) 120 (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the MPS 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the MPS 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the MPS 100 is configured to play back audio from a first playback device (e.g., the playback device 110a) in synchrony with a second playback device (e.g., the playback device 110b). Interactions between the playback devices 110, NMDs 120, and/or control devices 130 of the MPS 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The MPS 100 can comprise one or more playback zones, some of which may correspond to the rooms in the environment 101. The MPS 100 can be established with one or more playback zones, after which additional zones may be added, or removed to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the patio 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices.

Referring to FIG. 1B, the home environment may include additional and/or other computing devices, including local network devices, such as one or more smart illumination devices 108, a smart thermostat 140, and a local computing device 105 (FIG. 1A). In embodiments described below, one or more of the various playback devices 110 may be configured as portable playback devices, while others may be configured as stationary playback devices. For example, the headphones 1100 (FIG. 1B) are a portable playback device, while the playback device 110e on the bookcase may be a stationary device. As another example, the playback device 110c on the Patio may be a battery-powered device, which may allow it to be transported to various areas within the environment 101, and outside of the environment 101, when it is not plugged in to a wall outlet or the like.

With reference still to FIG. 1B, the various playback, network microphone, and controller devices and/or other network devices of the MPS 100 may be coupled to one another via point-to-point connections and/or over other connections, which may be wired and/or wireless, via a local network 160 that may include a network router 109. For example, the playback device 110j in the Den 101d (FIG. 1A), which may be designated as the “Left” device, may have a point-to-point connection with the playback device 110k, which is also in the Den 101d and may be designated as the “Right” device. In a related embodiment, the Left playback device 110j may communicate with other network devices, such as the playback device 110h, which may be designated as the “Front” device, via a point-to-point connection and/or other connections via the local network 160.

The local network 160 may be, for example, a network that interconnects one or more devices within a limited area (e.g., a residence, an office building, a car, an individual's workspace, etc.). The local network 160 may include, for example, one or more local area networks (LANs) such as a wireless local area network (WLAN) (e.g., a Wi-Fi network, a Z-Wave network, etc.) and/or one or more personal area networks (PANs) (e.g. a Bluetooth network, a wireless USB network, a ZigBee network, an IRDA network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “Wi-Fi” can refer to several different communication protocols including, for example, Institute of Electrical and Electronics Engineers (IEEE) 802.11a, 802.11b, 802.11g, 802.12, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, 6 GHz, and/or another suitable frequency.

The MPS 100 is configured to receive media content from the local network 160. The received media content can comprise, for example, a Uniform Resource Identifier (URI) and/or a Uniform Resource Locator (URL). For instance, in some examples, the MPS 100 can stream, download, or otherwise obtain data from a URI or a URL corresponding to the received media content.

As further shown in FIG. 1B, the MPS 100 may be coupled to one or more remote computing devices 106 via a wide area network (“WAN”) 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the environment 101 (FIG. 1A).

In some implementations, the various playback devices 110, NMDs 120, and/or control devices 130 may be communicatively coupled to at least one remote computing device associated with a voice assistant service (“VAS”) and/or at least one remote computing device associated with a media content service (“MCS”). For instance, in the illustrated example of FIG. 1B, remote computing devices 106a are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some embodiments, the various playback devices 110, NMDs 120, and/or control devices 130 may transmit data associated with a received voice input to a VAS configured to (i) process the received voice input data and (ii) transmit a corresponding command to the MPS 100. In some aspects, for example, the computing devices 106a may comprise one or more modules and/or servers of a VAS. In some implementations, VASes may be operated by one or more of SONOS®, AMAZON®, GOOGLE® APPLE®, MICROSOFT®, NUANCE®, or other voice assistant providers. In some implementations, MCSes may be operated by one or more of SPOTIFY, PANDORA, AMAZON MUSIC, YOUTUBE MUSIC, APPLE MUSIC, or other media content services.

In some embodiments, the local network 160 comprises a dedicated communication network that the MPS 100 uses to transmit messages between individual devices and/or to transmit media content to and from MCSes. In certain embodiments, the local network 160 is configured to be accessible only to devices in the MPS 100, thereby reducing interference and competition with other household devices. In other embodiments, however, the local network 160 comprises an existing household communication network (e.g., a household Wi-Fi network). In some embodiments, the MPS 100 is implemented without the local network 160, and the various devices comprising the MPS 100 can communicate with each other, for example, via one or more direct connections, PANs, telecommunication networks (e.g., an LTE network or a 5G network, etc.), and/or other suitable communication links.

In some embodiments, audio content sources may be regularly added or removed from the MPS 100. In some embodiments, for example, the MPS 100 performs an indexing of media items when one or more media content sources are updated, added to, and/or removed from the MPS 100. The MPS 100 can scan identifiable media items in some or all folders and/or directories accessible to the various playback devices and generate or update a media content database comprising metadata (e.g., title, artist, album, track length) and other associated information (e.g., URIs, URLs) for each identifiable media item found. In some embodiments, for example, the media content database is stored on one or more of the various playback devices, network microphone devices, and/or control devices of MPS 100.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 110 may take the form of or include an on-board (e.g., integrated) network microphone device configured to receive voice utterances from a user. For example, the playback devices 110c-110h, and 110k include or are otherwise equipped with corresponding NMDs 120c-120h, and 120k, respectively. A playback device that includes or is equipped with an NMD may be referred to herein interchangeably as a playback device or an NMD unless indicated otherwise in the description. In some cases, one or more of the NMDs 120 may be a stand-alone device. For example, the NMD 1201 may be a stand-alone device. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various playback and network microphone devices 110 and 120 of the MPS 100 may each be associated with a unique name, which may be assigned to the respective devices by a user, such as during setup of one or more of these devices. For instance, as shown in the illustrated example of FIG. 1B, a user may assign the name “Bookcase” to playback device 110e because it is physically situated on a bookcase. Similarly, the NMD 1201 may be assigned the named “Island” because it is physically situated on an island countertop in the Kitchen 101h (FIG. 1A). Some playback devices may be assigned names according to a zone or room, such as the playback devices 110g, 110d, and 110f, which are named “Bedroom,” “Dining Room,” and “Office,” respectively. Further, certain playback devices may have functionally descriptive names. For example, the playback devices 110k and 110h are assigned the names “Right” and “Front,” respectively, because these two devices are configured to provide specific audio channels during media playback in the zone of the Den 101d (FIG. 1A). The playback device 110c in the Patio may be named “Portable” because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 120 are configured to interact with the VAS 190 over the local network 160 and/or the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 105, 110, 120, and 130 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. Patent Publication No. 2017-0242653 published Aug. 24, 2017, and titled “Voice Control of a Media Playback System,” which is herein incorporated by reference in its entirety.

Upon receiving the stream of sound data, the VAS 190 may determine if there is voice input in the streamed data from the NMD, and if so the VAS 190 may also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the NIPS 100 or indirectly via the VAS 190. In some implementations, the VAS 190 may transmit to the NIPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 110e in the environment 101 (FIG. 1A) is in relatively close proximity to the NMD-equipped Living Room playback device 120b, and both devices 110e and 120b may at least sometimes detect the same sound. In such cases, this may require arbitration as to which device is ultimately responsible for providing detected-sound data to the remote VAS. Examples of arbitrating between NMDs may be found, for example, in previously referenced U.S. Patent Publication No. 2017-0242653.

In certain implementations, an NMD may be assigned to, or otherwise associated with, a designated or default playback device that may not include an NMD. For example, the Island NMD 1201 in the Kitchen 101h (FIG. 1A) may be assigned to the Dining Room playback device 110d, which is in relatively close proximity to the Island NMD 1201. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Patent Publication No. 2017-0242653.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the playback devices 110, network microphone devices 120, and/or control devices 130. For example, the technologies herein may be utilized within an environment having a single playback device 110 and/or a single NMD 120. In some examples of such cases, the local network 160 (FIG. 1B) may be eliminated and the single playback device 110 and/or the single NMD 120 may communicate directly with the remote computing devices 106a-c. In some embodiments, a telecommunication network (e.g., an LTE network, a 5G network, etc.) may communicate with the various playback devices 110, network microphone devices 120, and/or control devices 130 independent of the local network 160.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, Wi-Fi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 150 via the input/output 111 (e.g., a cable, a wire, a PAN, a Bluetooth connection, an ad hoc wired or wireless communication network, and/or another suitable communication link). The local audio source 150 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 150 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 150. In other embodiments, however, the media playback system omits the local audio source 150 altogether. In some embodiments, the playback device 110a does not include an input/output 111 and receives all audio content via the local network 160.

The playback device 110a further comprises electronics 112, a user interface 113 (e.g., one or more buttons, knobs, dials, touch-sensitive surfaces, displays, touchscreens), and one or more transducers 114 (e.g., a driver), referred to hereinafter as “the transducers 114.” The electronics 112 is configured to receive audio from an audio source (e.g., the local audio source 150) via the input/output 111, one or more of the computing devices 106a-c via the local network 160 (FIG. 1i)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g, one or more audio amplifiers 112h (referred to hereinafter as “the amplifiers 112h”), and power components 112i (e.g., one or more power supplies, power cables, power receptacles, batteries, induction coils, Power-over Ethernet (POE) interfaces, and/or other suitable sources of electric power).

In some embodiments, the electronics 112 optionally include one or more other components 112j (e.g., one or more sensors, video displays, touchscreens, battery charging bases). In some embodiments, the playback device 110a and electronics 112 may further include one or more voice processing components that are operably coupled to one or more microphones, and other components as described below with reference to FIGS. 1F and 1G.

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1i)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the MPS 100. In some aspects, for example, the state data is shared during predetermined intervals of time (e.g., every 5 seconds, every 10 seconds, every 60 seconds) among at least a portion of the devices of the MPS 100, so that one or more of the devices have the most recent data associated with the MPS 100.

The network interface 112d is configured to facilitate a transmission of data between the playback device 110a and one or more other devices on a data network. The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the local network 160 (FIG. 1B) in accordance with a suitable wireless communication protocol (e.g., Wi-Fi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

In some implementations, the power components 112i of the playback device 110a may additionally include an internal power source (e.g., one or more batteries) configured to power the playback device 110a without a physical connection to an external power source. When equipped with the internal power source, the playback device 110a may operate independent of an external power source. In some such implementations, an external power source interface may be configured to facilitate charging the internal power source. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The user interface 113 may facilitate user interactions independent of or in conjunction with user interactions facilitated by one or more of the control devices 130 (FIG. 1A). In various embodiments, the user interface 113 includes one or more physical buttons and/or supports graphical interfaces provided on touch sensitive screen(s) and/or surface(s), among other possibilities, for a user to directly provide input. The user interface 113 may further include one or more of lights (e.g., LEDs) and the speakers to provide visual and/or audio feedback to a user.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

In some embodiments, the playback device 110a may include a speaker interface for connecting the playback device to external speakers. In other embodiments, the playback device 110a may include an audio interface for connecting the playback device to an external audio amplifier or audio-visual receiver.

By way of illustration, SONOS, Inc. presently offers (or has offered) for sale certain playback devices including, for example, a “SONOS ONE,” “SONOS ONE SL,” “SONOS FIVE,” “PLAY:1,” “PLAY:3,” “PLAY:5,” “PLAYBAR,” “PLAYBASE,” “BEAM,” “ARC,” “CONNECT:AMP,” “CONNECT,” “AMP,” “PORT,” “MOVE,” and “SUB,” as well as network devices including, for example “BOOST,” and “BRIDGE.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1i). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with playback device 110i, is configured to render only the mid-range and high frequency components of a particular audio content, while the playback device 110i renders the low frequency component of the particular audio content. In some embodiments, the bonded playback device 110q includes additional playback devices and/or another bonded playback device.

In some embodiments, one or more of the playback devices 110 may take the form of a wired and/or wireless headphone (e.g., an over-ear headset, an on-ear headset, or an in-ear headset). For instance, FIG. 4 shows an example headset assembly 400 (“headset 400”) for such an implementation of one of the playback devices 110. As shown, the headset 400 includes a headband 402 that couples a first earcup 404a to a second earcup 404b. Each of the earcups 404a and 404b may house any portion of the electronic components in the playback device 110, such as one or more speakers. Further, one or more of the earcups 404a and 404b may include a user interface for controlling audio playback, volume level, and other functions. The user interface may include any of a variety of control elements such as a physical button 408, a slider, a knob, and/or a touch control surface. As shown in FIG. 4, the headset 400 may further include ear cushions 406a and 406b that are coupled to ear cups 404a and 404b, respectively. The ear cushions 406a and 406b may provide a soft barrier between the head of a user and the earcups 404a and 404b, respectively, to improve user comfort and/or provide acoustic isolation from the ambient (e.g., passive noise reduction (PNR)).

As described in greater detail below, the electronic components of a playback device may include one or more network interface components (not shown in FIG. 4) to facilitate wireless communication over one more communication links. For instance, a playback device may communicate over a first communication link 401a (e.g., a Bluetooth link) with one of the control devices 130 and/or over a second communication link 401b (e.g., a Wi-Fi or cellular link) with one or more other computing devices 410 (e.g., a network router and/or a remote server). As another possibility, a playback device may communicate over multiple communication links, such as the first communication link 401a with the control device 130a and a third communication link 401c (e.g., a Wi-Fi or cellular link) between the control device 130a and the one or more other computing devices 410. Thus, the control device 130a may function as an intermediary between the playback device and the one or more other computing devices 410, in some embodiments.

In some instances, the headphone device may take the form of a hearable device. Hearable devices may include those headphone devices (including ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.).

It should be appreciated that one or more of the playback devices 110 may take the form of other wearable devices separate and apart from a headphone. Wearable devices may include those devices configured to be worn about a portion of a subject (e.g., a head, a neck, a torso, an arm, a wrist, a finger, a leg, an ankle, etc.). For example, the playback devices 110 may take the form of a pair of glasses including a frame front (e.g., configured to hold one or more lenses), a first temple rotatably coupled to the frame front, and a second temple rotatable coupled to the frame front. In this example, the pair of glasses may comprise one or more transducers integrated into at least one of the first and second temples and configured to project sound towards an ear of the subject.

c. Suitable Network Microphone Devices (NMD)s

FIG. 1F is a block diagram of the NMD 120a (FIGS. 1A and 1). The NMD 120a includes one or more voice processing components 124 and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise any or all of the components of the playback device 110a and further include the microphones 115 and voice processing components 124 (FIG. 1F). The microphones 115 are configured to detect sound (i.e., acoustic waves) in the environment of the playback device 110r, which is then provided to voice processing components 124. More specifically, each microphone 115 is configured to detect sound and convert the sound into a digital or analog signal representative of the detected sound, which can then cause the voice processing component to perform various functions based on the detected sound, as described in greater detail below. In some implementations, the microphones 115 may be arranged as an array of microphones (e.g., an array of six microphones). In some implementations the playback device 110r may include fewer than six microphones or more than six microphones. The playback device 110r optionally includes an integrated control device 130c. The control device 130c can comprise, for example, a user interface configured to receive user input (e.g., touch input, voice input) without a separate control device. In other embodiments, however, the playback device 110r receives commands from another control device (e.g., the control device 130a of FIG. 1).

In operation, the voice-processing components 124 are generally configured to detect and process sound received via the microphones 115, identify potential voice input in the detected sound, and extract detected-sound data to enable a VAS, such as the VAS 190 (FIG. 1), to process voice input identified in the detected-sound data. The voice processing components 124 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 124 may include or otherwise take the form of one or more DSPs or one or more modules of a DSP. In this respect, certain voice processing components 124 may be configured with particular parameters (e.g., gain and/or spectral parameters) that may be modified or otherwise tuned to achieve particular functions. In some implementations, one or more of the voice processing components 124 may be a subcomponent of the processor 112a.

In some implementations, the voice-processing components 124 may detect and store a user's voice profile, which may be associated with a user account of the MPS 100. For example, voice profiles may be stored as and/or compared to variables stored in a set of command information or data table. The voice profile may include aspects of the tone of frequency of a user's voice and/or other unique aspects of the user's voice, such as those described in previously-referenced U.S. Patent Publication No. 2017-0242653.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Controller Devices

FIG. 1H is a partially schematic diagram of one example of the control device 130a (FIGS. 1A and 1B). As used herein, the term “control device” can be used interchangeably with “controller,” “control device,” or “control system.” Among other features, the control device 130a is configured to receive user input related to the MPS 100 and, in response, cause one or more devices in the MPS 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the MPS 100. In other embodiments, as described above with respect to FIG. 1G, the control device 130a is integrated into another device in the MPS 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the MPS 100. The memory 132b can comprise data storage that can be loaded with one or more of the software components executable by the processors 132a to perform those functions. The software components 132c can comprise applications and/or other executable software configured to facilitate control of the MPS 100. The memory 132b can be configured to store, for example, the software components 132c, media playback system controller application software, and/or other data associated with the MPS 100 and the user.

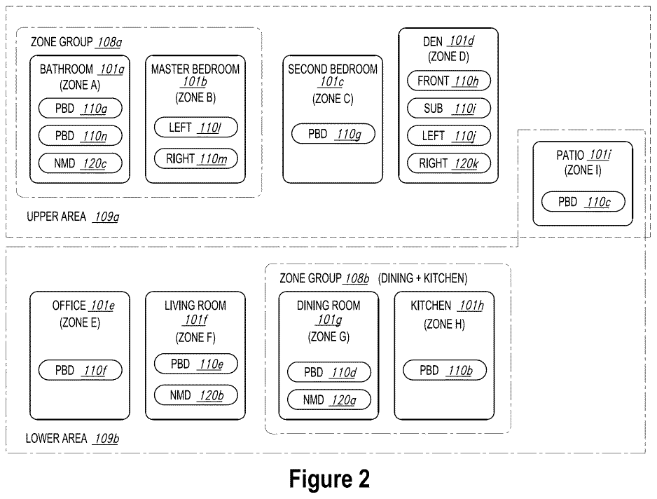

The network interface 132d is configured to facilitate network communications between the control device 130a and one or more other devices in the MPS 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.12, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1J through 2.

The user interface 133 is configured to receive user input and can facilitate control of the MPS 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system. FIG. 1I shows two additional user interface displays 133f and 133g of user interface 133. Additional examples are also possible.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

e. Suitable Playback Device Configurations

FIGS. 1J through 2 show example configurations of playback devices in zones and zone groups. Referring first to FIG. 2, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback zones 110g and 110h can be merged to form a merged group or a zone group 108b. The merged playback zones 110g and 110h may not be specifically assigned different playback responsibilities. That is, the merged playback zones 110h and 110i may, aside from playing audio content in synchrony, each play audio content as they would if they were not merged.

Each zone in the MPS 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1J, the playback devices 110l and 110m may be bonded so as to produce or enhance a stereo effect of audio content. In this example, the playback device 110l may be configured to play a left channel audio component, while the playback device 110k may be configured to play a right channel audio component. In some implementations, such stereo bonding may be referred to as “pairing.”

Additionally, bonded playback devices may have additional and/or different respective speaker drivers. As shown in FIG. 1K, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1L shows the Front and SUB devices 110h and 110i further bonded with Left and Right playback devices 110j and 110k, respectively. In some implementations, the Right and Left devices 110j and 110k can be configured to form surround or “satellite” channels of a home theater system. The bonded playback devices 110h, 110i, 110j, and 110k may form a single Zone D (FIG. 2).

Playback devices that are merged may not have assigned playback responsibilities and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 2, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 2. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “al” to identify playback device(s) of a zone, a second type “bl” to identify playback device(s) that may be bonded in the zone, and a third type “c1” to identify a zone group to which the zone may belong. As a related example, identifiers associated with the second bedroom 101c may indicate that the playback device 110g is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1M). Identifiers associated with the Kitchen may indicate the same or similar information by virtue of the Kitchen being part of the Dining+Kitchen zone group 108b. Other example zone variables and identifiers are described below.

In yet another example, the MPS 100 may include variables or identifiers representing other associations of zones and zone groups, such as identifiers associated with Areas, as shown in FIG. 2. An area may involve a cluster of zone groups and/or zones not within a zone group. For instance, FIG. 2 shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the MPS 100 may not implement Areas, in which case the system may not store variables associated with Areas.

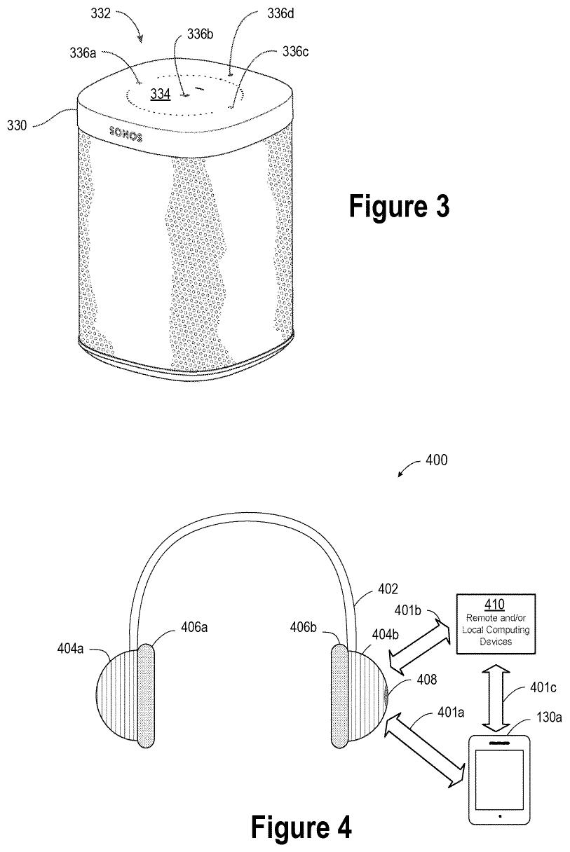

FIG. 3 shows an example housing 330 of the playback device 110 that includes a user interface in the form of a control area 332 at a top portion 334 of the housing 330. The control area 332 includes buttons 336a, 336b, and 336c for controlling audio playback, volume level, and other functions. The control area 332 also includes a button 336d for toggling the microphones 115 to either an on state or an off state. The control area 332 is at least partially surrounded by apertures formed in the top portion 334 of the housing 330 through which the microphones 115 (not visible in FIG. 3) receive the sound in the environment of the playback device 110. The microphones 115 may be arranged in various positions along and/or within the top portion 334 or other areas of the housing 330 so as to detect sound from one or more directions relative to the playback device 110.

In some embodiments, the playback device 110 may take the form of a wired and/or wireless headphone (e.g., an over-ear headset, an on-ear headset, or an in-ear headset). For instance, FIG. 4 shows an example headset assembly 400 (“headset 400”) for such an implementation of the playback device 110. As shown, the headset 400 includes a headband 402 that couples a first earcup 404a to a second earcup 404b. Each of the earcups 404a and 404b may house any portion of the electronic components in the playback device 110, such as one or more speakers. Further, one or more of the earcups 404a and 404b may include a user interface for controlling audio playback, volume level, and other functions. The user interface may include any of a variety of control elements such as a physical button 408, a slider, a knob, and/or a touch control surface. As shown in FIG. 4, the headset 400 may further include ear cushions 406a and 406b that are coupled to ear cups 404a and 404b, respectively. The ear cushions 406a and 406b may provide a soft barrier between the head of a user and the earcups 404a and 404b, respectively, to improve user comfort and/or provide acoustic isolation from the ambient (e.g., passive noise reduction (PNR)).

### III. Example Techniques for Intelligent Setup of a Playback Device

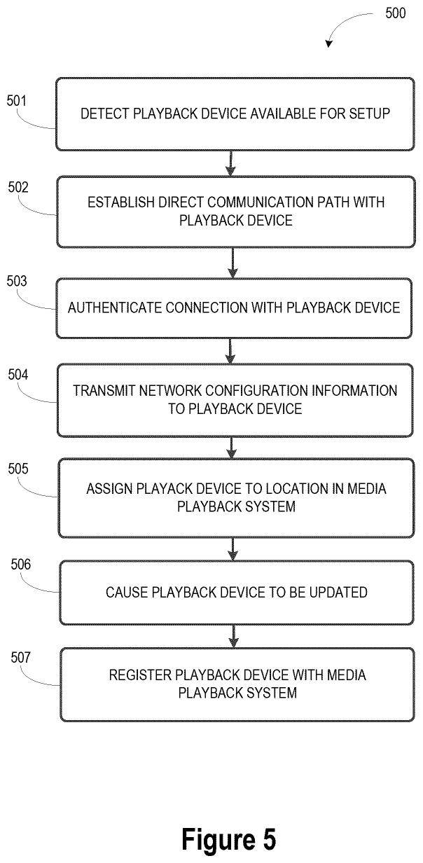

FIG. 5 illustrates a flowchart 500 that presents a high-level overview of the steps that may be involved in setting up a new playback device, such as any of the example playback devices 110 discussed above. As noted above, each of these steps may differ (e.g., including one or more different sub-steps) based on the capabilities of the playback device that is being set up, the computing device that is being used to implement the setup procedure, the user's home network environment, and/or the existence of other playback devices already connected to the user's media playback system, among other factors. As shown in FIG. 5, the steps may generally include (i) detecting a playback device that is available for setup, (ii) establishing a direct connection to the playback device, (iii) authenticating the direct connection with the playback device, (iv) passing network configuration credentials to the playback device that are used to connect to the user's network and the media playback system, (v) assigning the playback device to a location within the media playback system, (vi) updating the playback device, as necessary, (vii) securely registering the playback device with the media playback system, and (viii) optionally presenting the user with one or more options to set up additional features that are relevant to the playback device.

In the following paragraphs, the high-level steps shown in FIG. 5 will be discussed in turn, including some specific implementations and examples of each. Although the examples below will generally be presented with reference to a control device, such as control device 130 (e.g., a smartphone), that is setting up a new playback device as part of a media playback system, such as MPS 100, operating on a user's home Wi-Fi network, it should be understood that numerous other types of network-connected devices and other types of networking environments are also contemplated herein.

a. Detect a Playback Device Available for Setup

At block 501, the control device 130 may initially detect, via one or more communication paths, that a playback device 110 is available for setup. In practice, this step of playback device detection, as a precursor to establishing a direct connection between the playback device and the control device 130, may involve various actions that are carried out by the playback device 110 and the control device 130. For instance, the playback device 110 may be configured to automatically transmit one or more beacons advertising that the playback device 110 is available for setup when it is powered on in an unconfigured state. In this regard, a playback device may be deemed to be unconfigured if it is not currently registered with a media playback system. This may include, for instance, a brand new playback device or a playback device that is manually reset to its factory settings, thereby erasing previous registration information.

As another possibility, a playback device 110 may be configured to enter a setup mode based on a manual input from a user, such as a button press on the playback device 110. This may be desirable in some situations, such as when a user changes the network configuration information (e.g., an SSID and/or password) for their home WiFi network. In this case, the previously connected playback device 110 may still be registered as a member of the user's MPS 100, but it may now be unable to connect to the user's home Wi-Fi network. Thus, a manual activation of the setup mode on the playback device 110 may be needed to reestablish its connection to the network.

The beacon(s) transmitted by the playback device 110 to advertise its availability for setup may take various forms, depending on the hardware and networking capabilities of the playback device 110. A beacon as discussed herein may refer to a message that is transmitted periodically, as an ongoing advertisement of the playback device's availability for setup over a given communication path. As one possibility, if the playback device 110 includes a wired Ethernet port and the user has connected the playback device 110 to their home local area network (LAN) via a wired connection, the playback device 110 may transmit a beacon over the wired connection to the LAN. As another possibility, the playback device 110 may include one or more wireless network interfaces that enable it to communicate via one or more different wireless protocols, such as Bluetooth (e.g., Bluetooth Low Energy (BLE)) and/or WiFi. For instance, the playback device 110 may transmit a BLE beacon advertising the availability of a BLE connection to the playback device 110. Additionally or alternatively, the playback device 110 may transmit a beacon over WiFi, acting as an open access point (AP) that is detectable to other devices with WiFi connection capability. As another possibility, if the playback device 110 contains an APPLE® Wireless Accessory Configuration (WAC) chip, which is used for connecting accessories to iOS devices, the playback device 110 may transmit a WAC beacon that may be detectable by, for instance, an iPhone™ or an iPad™. In some cases, the playback device 110 may transmit a beacon advertising its availability for setup over multiple communication paths that it is capable of using. Numerous other types of beacons and communication paths are also possible.

The control device 130 that is used to facilitate the setup of playback device 110 will generally be installed with software to assist the user with establishing a direct connection to the playback device, setting up the playback device 110, and then for eventually controlling the playback device 110. In some cases, the software may be natively included within the operating system of the control device 130. In other examples, the user may install a dedicated media playback system controller application on their control device 130. In the case of a newly created media playback system, the controller application may first guide the user through the creation of a user account (e.g., an account with the media playback system provider, such as a Sonos user account) and a media playback system identifier (e.g., a household identifier or “HHID”), which may be used as a basis to uniquely register the playback device 110 as belonging to the user, and to the user's media playback system, later in the setup process. In addition, the media playback system controller application may prompt the user to grant certain permissions to the application, such as Bluetooth access and Location services, which may be required to perform scanning of available WiFi networks.

The control device 130 may further include one or more wireless network interfaces, which it may use to scan for beacons from any advertising playback devices. For instance, the media playback system controller application may, whenever it is running, cause the control device 130 to passively (e.g., periodically) scan for available devices over each communication path that the control device 130 is capable of using (e.g., BLE, WiFi, and/or WAC). Advantageously, this may allow for the discovery of the playback device 110 for setup while requiring little or no input by the user. As another possibility, a user may manually select an option within the media playback system controller application, such as an “Add A Product” command, that may cause the control device 130 to undertake an active scan that polls for available devices more frequently than the passive scan.

As a result of the scan, the control device 130 may detect one or more beacons from the playback device 110, possibly over multiple connections. For example, the control device 130 may detect, via its WiFi connection to the user's LAN, a beacon transmitted by the playback device 110 over a wired Ethernet connection, as well as a BLE beacon via its BLE connection. Further, the beacon itself may include certain identifying information about the playback device 110, such as a serial number and/or model number, which the control device 130 may use to determine the playback device's networking capabilities. In this way, the control device 130 might detect a WiFi beacon over the playback device's open AP that indicates that the playback device 110 is a model that supports BLE, even though the control device 130 has not yet detected a BLE beacon.

Based on the foregoing discussion, it will be appreciated that the control device 130 may be configured to support numerous possibilities for establishing a direct connection to the playback device 110, and to select a preferred connection type from a set of possible connections when more than one is detected. For example, if the playback device 110 is detected over multiple connections, the control device 130 may prefer a LAN connection over a BLE connection, and a BLE connection over a WAC or open AP connection. Preferred connection types may be established with more granularity as well. For instance, a WAC connection may be preferred over an open AP connection, but only for the first playback device of a new media playback system. For a second playback device and every playback device thereafter, an open AP connection may be preferred to WAC. Other examples are also possible.

In some implementations, the control device 130 may delay selection of a direct connection type if it determines from a detected beacon that the playback device 110 supports a more preferred connection, even though a beacon over that connection has not yet been received. For instance, the control device 130 may discover the playback device 110 over WiFi only, while the identifying information in the beacon may indicate that the playback device 110 is a model that supports both a wired LAN connection and a BLE connection. Accordingly, the control device 130 may delay presentation of a setup prompt to the user for a brief period (e.g., 15 seconds, 30 seconds, one minute, etc.). This may allow for the playback device 110 to be discovered over the wired LAN if the user did not plug an Ethernet cable into the playback device until after powering it up, for instance. As another possibility, the brief delay may allow the user to move the control device 130, which may be in another room, for example, closer to the playback device 110 such that it is within BLE range. Nonetheless, if a more preferred connection is not detected after the delay, the control device 130 may display a pop-up window or similar notification that the playback device 110 is available for setup and prompt the user to proceed.

As yet another possibility, during the brief delay to detect the playback device 110 over a more preferred connection type, the control device 130 may retrieve additional information associated with the playback device 110. For example, the control device 130 may communicate with a cloud-based computing system to retrieve authentication information for the playback device 110 based on the identifying information (e.g., a serial number) that the control device 130 detected in the beacon. The authentication information may be, for instance, a copy of a manufacturing certificate for the playback device 110, which may be used to authenticate communications with the playback device 110 later in the setup process. In this regard, the control device 130 may briefly delay presentation of a notification to the user even if a most preferred connection type is available, to allow the control device 130 to retrieve the authentication information. Numerous other possibilities also exist, including retrieving the authentication information in parallel with presenting a notification to the user.

Additionally or alternatively, the control device 130 may implement a brief delay between detecting the playback device 110 and displaying a user setup prompt in order to increase the likelihood that the control device 130 detects all playback devices that are available for setup. In some embodiments, the control device 130 might detect that more than one playback device is available for setup, which might occur if the user is setting up multiple devices. In these situations, the multiple detected devices may be presented as a carousel of pop-up windows or similar menu items, which may be initially ordered in such a way that facilitates the overall setup experience. For example, the control device 130 may prioritize the setup prompt for a playback device that is relatively more likely to serve as a coordinating device for a home theater configuration or other bonded group arrangement, such as a soundbar. This may facilitate the subsequent setup of other playback devices that may be bonded to the soundbar as surround speakers during the initial setup process. Conversely, the control device 130 may deprioritize the setup prompt for a playback device, such as a subwoofer, that is generally only added to a media playback system by bonding it to another playback device. This may allow for other playback devices, which may be potential bonding partners for the subwoofer, to be set up first, facilitating the subsequent setup of the subwoofer.

The control device 130 may determine the presentation order among multiple available playback devices based on other factors as well, such as the detected connection type(s) for each available device (e.g., prioritizing playback devices capable of a more preferred connection type), a wireless signal strength associated with each playback device's respective beacons (e.g., prioritizing playback devices whose beacons have a relatively stronger detected signal strength and/or deprioritizing playback devices whose beacons have a relatively weaker signal strength), and/or the type and number of playback devices already connected to the user's media playback system (e.g., prioritizing playback devices that are compatible as members of a bonded synchrony group with playback devices already in the system), among numerous other possibilities, either alone or in combination with those noted above.

Further, regardless of any preferred presentation order that the control device 130 may determine among multiple playback devices that are available for setup, the control device 130 may nonetheless allow the user to scroll through the available devices (e.g., by rotating a carousel of pop-up cards) to select a particular playback device for setup. As another possibility, the control device 130 may allow the user to dismiss a prompt to set up a given playback device. For example, the user may want to set up their device(s) at a later time. As another example, the control device 130 might be within range of another media playback system, such as a neighbor's system, and may detect one of the neighbor's playback devices that is available for setup. Accordingly, the user may dismiss the prompt to set up the neighbor's playback device. Additional safeguards to help reduce the likelihood of a user setting up an unintended playback device are discussed below.

b. Establish a Direct Communication Path

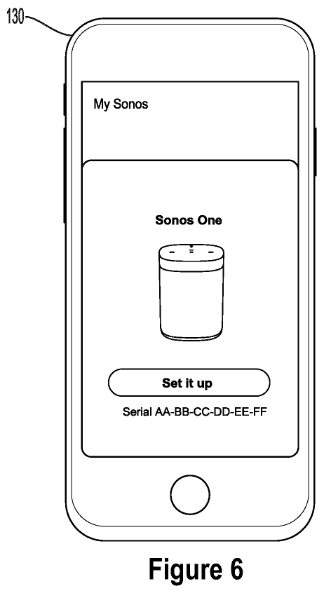

At block 502, a direct communication path between the control device 130 and the playback device 110 may be established in various ways. As an initial step, after the control device 130 detects that the playback device 110 is available for setup, the control device 130 may present a notification (e.g., a pop-up window) informing the user that playback device 110 has been detected and prompting the user to confirm whether they wish to proceed with the setup process. An example of such a notification can be seen in FIG. 6. As shown in the example, the notification may, using the identifying information contained in the beacon, refer to the playback device 110 by model number (e.g., a Sonos One model playback device), and may further present a depiction (e.g., size, shape, color, etc.) of the playback device 110. In some cases, the notification may further include a serial number for the playback device 110, which may help the user to verify that they are setting up the intended device. For instance, the user may match the displayed serial number to the same number printed on the playback device 110.

The control device 130 may then detect an input to proceed with setup of the playback device 110. The input may cause the control device 130 to transmit a message to the playback device 110 over the communication path corresponding to the detected beacon.

For any of the wireless communication modes discussed above (e.g., BLE, WAC, open AP), this message may serve to establish a direct communication path with the playback device 110. As the direct communication path is established, the control device 130 may present an indication that setup is proceeding. Further, the message transmitted by the control device 130 may include a command for the playback device 110 to begin a setup routine, as discussed further below.

In some cases, the playback device 110 that is being set up may be a portable playback device (e.g., the headphone device 110o shown in FIG. 1B) that supports the capability to connect to the user's WiFi network as well as the capability to connect via Bluetooth pairing to the control device 130. In these situations, if the portable playback device 110 has not yet been paired with the control device 130, the user may be prompted with an option to pair the portable playback device 110 with the control device 130 via Bluetooth when it is first detected. After Bluetooth pairing is completed successfully, the control device 130 may provide the user with an option to continue setting up the portable playback device 110 to operate over the user's Wi-Fi network as well.

The initial messages discussed above may be exchanged between the control device 130 and the playback device 110 over the direct communication path using a Datagram Transport Layer Security (DTLS) protocol, regardless of which type of communication path is established. In this regard, it will be appreciated that, in cases where the initial, direct communication path is established between the control device 130 and the playback device 110 over a BLE communication link, the direct communication path may not involve BLE pairing, nor the encryption associated therewith. Rather, the DTLS datagrams may be transmitted over the BLE communication link, perhaps in connection with a transport layer that provides for segmentation and reassembly of the datagrams due to the possibility of bandwidth constraints of BLE communications in relation to WAC or WiFi communications.

In some implementations, a packet acknowledgement retransmission layer may also be implemented on one or both devices to increase the reliability of the DTLS communications. For instance, the control device 130 or the playback device 100 may transmit an acknowledgement message to the other device for each received data packet it receives from the other device. Further, because the devices will generally be engaged in a back-and-forth exchange of initial setup messages, the control device 130 and/or the playback device 100 may postpone transmission of one or more acknowledgement messages if it determines that it will be transmitting a planned message as part of the initial setup process. Thus, the one or more postponed acknowledgement messages may be packaged with the planned message so as to reduce the number of messages that are transmitted over the direct communication path. Numerous other implementations and variations are also possible.

c. Authenticate Connection to the Playback Device

At block 503, one or both of the control device 130 and the playback device 110 may undertake an authentication process for communications between the two devices. Because the control device 130 will eventually pass sensitive network configuration parameters for connecting to the user's home network (e.g., SSID, password, etc.) to the playback device 110, it may be desirable to establish a secure and trustworthy connection between the control device 130 and the playback device 110 over the direct communication path before such information is exchanged. In particular, providing for a two-way authentication in which the control device 130 verifies the playback device 110, and the playback device 110 verifies the control device 130, may help to prevent various different types of setup issues that may occur—including both innocent mistakes as well as malicious attempts to gain access to or otherwise affect the user's network. For instance, two-way authentication may prevent a user from accidentally using their control device 130 to set up an unintended playback device (e.g., a neighbor's playback device, or a malicious, spoofed playback device). Similarly, it may prevent the user's playback device 110 from being set up by an unintended control device.

Secure authentication between the control device 130 and the playback device 110 may take various forms. As one possibility, the playback device 110 may pass a PIN code to the control device 130 outside of the direct communication path, and in a way that requires the control device 130 to be located proximate to the playback device 110. The two devices can then verify to each other, over the direct communication path, that they both know the shared PIN code. For example, the PIN code may be passed using near-field communications (NFC), if both devices support such communications. As another example, the playback device 110 may use audio modulation to transmit the PIN code via one or more high-frequency tones that are not audible to the human ear but are detectable by a microphone of the control device 130. Additional details regarding the transmission of information via audio modulation can be found in U.S. Pat. No. 8,930,005, which was incorporated by reference above.

As yet another example, the playback device 110 may include a PIN code that is printed on the device (e.g., on the bottom of the device with the serial number), which the user may read and then manually enter into the control device 130. The PIN code may be passed from the playback device 110 to the control device 130 outside the direction communication path in other manners as well.

The type of authentication that is used by the two devices during the setup process may again depend on the hardware and software capabilities of one or both of the control device 130 and the playback device 110. In some cases, secure authentication using the PIN code exchange discussed above might not be available at all. For instance, many existing playback devices might not support NFC, or may have been manufactured before secure authentication PIN codes began to be printed on each playback device. Further, some devices within the MPS 100 may not have audio transducers (e.g., network devices, amplifier-only playback devices) such that audio modulation is not an option. Similarly, some playback devices may have one or more transducers that are not capable of audio output at the frequency range that may be used for audio modulation (e.g., a subwoofer). Still further, although many other playback devices discussed herein may include one or more loudspeakers such that the playback device is physically capable of supporting secure authentication via audio modulation, these playback devices may not have been updated such that they are configured to do so from a software perspective.

For example, secure authentication via audio modulation may require a playback device 110 to include software (e.g., firmware) such that the playback device 110 is configured to generate a PIN code (or store a pre-existing PIN code), transmit the PIN code via one or more high-frequency tones, and then conduct a two-way exchange and verification of the PIN code with the control device 130, among other things. Accordingly, playback devices that include firmware that pre-dates the introduction of the secure authentication techniques discussed herein may not support audio modulation. In a similar way, some playback devices may support NFC, or may include a printed PIN code that was applied to the playback device during the manufacturing process, in anticipation of secure authentication, but the playback device might not yet include the firmware to support the PIN code exchange and verification discussed above. Moreover, even if a firmware update to support these types of secure authentication is pushed to all existing playback devices, only powered-on, already-connected playback devices would receive the update.

For this reason, the control device 130 may be capable of supporting not only numerous different types of connections to a given playback device, but also numerous different authentication methods. In addition, unlike the playback device 110, the control device 130 will typically already be connected to the internet (e.g., via the user's WiFi network) when the setup process begins, and thus the control device 130 may generally be assumed to be operating with the most up-to-date version of the media playback system controller application. If it is not, the user may be prompted to update the application before setup begins (e.g., when the application is opened, or when the playback device 110 is first detected) to provide the best setup experience.

As noted above, the control device 130 may, in response to user input to start the setup process, transmit a message to the playback device 110 to begin a setup routine. In some implementations, this message may cause the playback device 110 to provide feedback in the form of an audible tone, which may increase the audible engagement of the user experience, as well as give the user confidence that setup is proceeding correctly. As another possibility, one or more LED lights on the playback device 110 may additionally begin flashing in a predetermined pattern. In some cases, a playback device that does not include an integrated loudspeaker, (e.g., an amplifier-only playback device) may be limited to an LED flashing pattern. As yet another possibility, a playback device that is connected to a display device during setup (e.g., a television) may cause the display device to present one or more visual indications to the user. Other implementations may also be possible, including any combination of the examples above.

The message transmitted to the playback device 110 to begin the setup routine may be based in part on identifying information that the control device 130 received in the playback device's beacon. In particular, the identifying information may include an indication of the firmware version that is installed on the playback device 110, in addition to conveying the playback device's hardware and networking capabilities, as discussed above. Based on this information, the control device 130 may determine what type(s) of authentication are possible and may select a preferred authentication method.

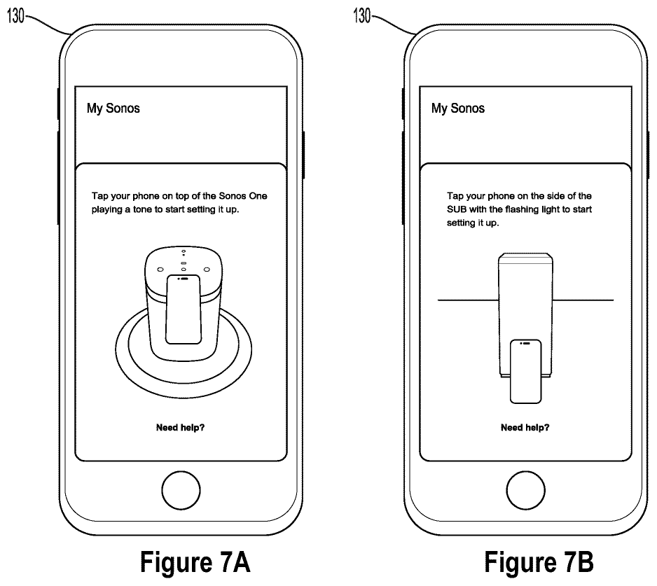

In one implementation, which may be a preferred implementation, the control device 130 may support NFC, and may determine from the beacon that the playback device 110 also supports NFC and is running a firmware version that supports secure NFC authentication. Thus, the message from the control device 130 to begin the setup routine may cause the playback device 110 to generate a PIN code and write it to its NFC tag. Additionally, after transmitting the message, the control device 130 may present an indication that provides an instruction for the user to tap the control device 130 to a certain location on the playback device 110 that corresponds to the location of the NFC tag. Examples of such an instruction are shown in FIGS. 7A and 7B.

As noted above, the message to begin the setup routine may cause the playback device 110 to provide one or more types of feedback to the user, such as an audible tone. This feedback may continue during the authentication process and may be referenced in the instructions that are provided to the user (e.g., an audible tone, a flashing light, etc.). As noted above, this may provide confirmation to the user that they are setting up the intended device and may generally enhance the level of audible engagement in the setup process.

When the user taps the control device 130 to the playback device 110, the PIN code may be passed to the control device 130 over NFC. Thereafter, the control device 130 and the playback device 110 may exchange messages over the direct communication path mutually verifying that the other device knows the same PIN code. In some cases, the playback device 110 may additionally transmit a copy of its manufacturing certificate during the exchange, which the control device 130 may verify based on the playback device's known serial number. The PIN code may then be used as a pre-shared key that provides relatively strong, mutual authentication for the DTLS communications between the control device 130 and the playback device 110 over the direct communication path. For example, the control device 130 may provide network configuration information for connection the user's WiFi network, as discussed below.

In some situations, if the sequencing of messages and message acknowledgments that are exchanged between the control device 130 and the playback device 110 leading up to an NFC scan is too rigid, the two devices may become out of sync such that the NFC scan is not successfully completed. For example, the control device 130 may initially instruct the playback device 110 to begin the NFC scanning process in a SETUP_BEGIN message, which may cause both devices to start a timeout window. However, if the control device 130 starts its window upon transmitting the message and the playback device 110 starts its window upon receiving the message, the playback device's window may be delayed—particularly if it takes one or more retransmissions for the message to reach the playback device 110. Alternatively, if the control device 130 waits until it receives an acknowledgement that the playback device 110 received the SETUP_BEGIN message, then the control device's window may be delayed—particularly if it takes one or more retransmissions for the acknowledgement to reach the playback device 110.

Due to the timeout windows for the NFC scan between the two devices being misaligned in this way, among other potential issues, it may be possible for one of the two devices to register a successful scan when the other device has reached the end of its timeout window, and thus the other device does not register the scan. If the control device 130 times out in this way, it may attempt to transmit a SETUP_CANCEL message or a new SETUP_BEGIN message, either of which may be ignored by the playback device 110 that is attempting to send a SETUP_CONTINUE message to report that it successfully registered the scan (e.g., transmitting/retransmitting and waiting for an acknowledgement). This SETUP_CONTINUE message from the playback device 110 may be ignored in turn by the control device 130. Conversely, if the playback device 110 times out, it may wait to receive another SETUP_BEGIN message, however the control device 130, which registered a successful scan, may be waiting for a SETUP_CONTINUE message from the playback device 110 that it is not forthcoming. In either scenario, it might take up to several minutes for both devices to recover such that they can start the operations again. This may create an undesirable user experience.

To address these potential issues, the communications between the two devices may be made more flexible, such that both the playback device 110 and the control device 130 can accept and acknowledge message at times when those messages would not normally be expected (e.g., at times when the receiving device is trying to send a different message). For example, the control device 130 may be configured to always accept and acknowledge a SETUP_CONTINUE message from the playback device 110, even if the control device 130 has timed out and is trying to send a message back to the playback device 110. By acknowledging the playback device's message, it may allow the playback device 110 to stop trying to send the SETUP_CONTINUE message and start listening again, which in turn may allow the playback device 110 to register the SETUP_CANCEL message and return to the beginning of the process and wait for a new SETUP_BEGIN message to start its timeout window again. Similarly, the playback device 110 may be configured to transmit a SETUP_TIMED_OUT message whenever it reaches the end of its timeout window. This may notify the control device 130 that it is not going to receive a SETUP_CONTINUE message, even if it registered a successful scan.

Other types of messages to facilitate successful NFC scanning are also possible. Further, the advantages discussed above may also be applied to other operations where the control device 130 and the playback device 110 need to exchange a sequence of messages and message acknowledgments.

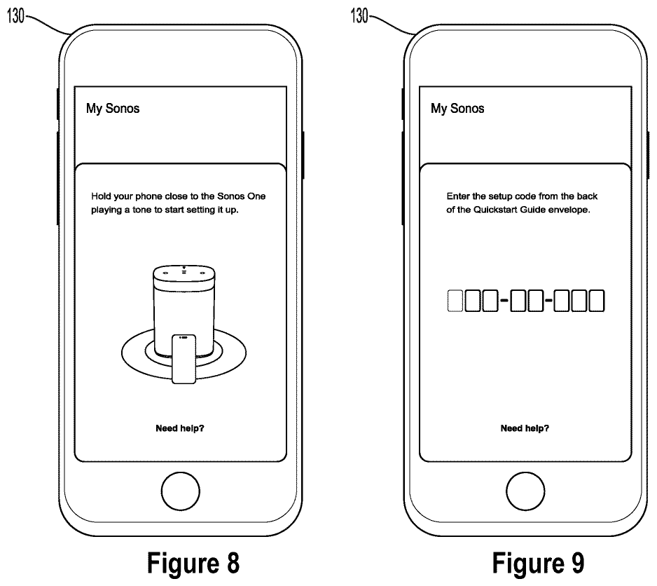

In another implementation, the control device 130 may determine that either it or the playback device 110 does not support NFC (e.g., the user declined to give the control application NFC access permissions) or that the NFC scanning operation was unsuccessful, but that the playback device 110 is running firmware that supports secure authentication via audio modulation. Alternatively, if the NFC authentication discussed above is started but fails for any reason (e.g., one or more unsuccessful NFC exchanges, a timeout period elapses, or the user manually backs out of the NFC authentication), the control device 130 may default to audio modulation as the next most preferred authentication, and may retransmit the message to begin setup. In either case, the message to begin setup may cause the playback device 110 to generate a PIN code and then transmit the PIN code via one or more high-frequency tones. Meanwhile, the control device 130 may present an indication that provides an instruction for the user to hold the control device 130 near the playback device that is playing back an audible tone. An example of this type of instruction is shown in FIG. 8. In these situations, although the PIN code is transmitted over a high-frequency range that may not be audible to the human ear, the playback device 110 may nonetheless present visual and/or audible feedback, as discussed above with respect to NFC authentication. In some cases, although it is not necessary for the exchange of the PIN code, the playback device 110 may play back a different, more distinctive tone during authentication via audio modulation, to simulate the transmission of the PIN code that is occurring over the higher-frequency.

Once the control device 130 receives the PIN code via one or more microphones, the authentication can proceed as above, whereby the control device 130 and the playback device 110 exchange messages over the direct communication path mutually verifying that the other device knows the same PIN code.

In yet another implementation, the control device 130 may determine that NFC authentication is not supported, and that the playback device 110 is not capable of audio modulation (e.g., an amplifier-only playback device), and/or that both of these authentication options have failed. Nonetheless, the playback device 110 may include a printed PIN code on the device, and it may be running firmware that supports the secure authentication via mutual PIN code exchange discussed above. Accordingly, the control device 130 may present an indication that provides an instruction for the user to manually enter the PIN code from the playback device 110 into the control application, thereby providing the control device 130 with the PIN code. An example of this type of instruction is provided in FIG. 9.

Alternatively, this type of manual PIN code entry may be used as a fallback for secure authentication in situations where one or both of the NFC and audio modulation authentication methods are unsuccessful, as noted above. In this regard, the printed PIN code that is provided on the device may only be used for this type of manual PIN entry—whereas the NFC and audio modulation authentication methods discussed above may use a PIN code that is randomly generated by the playback device 110 upon receipt of the message to begin setup.

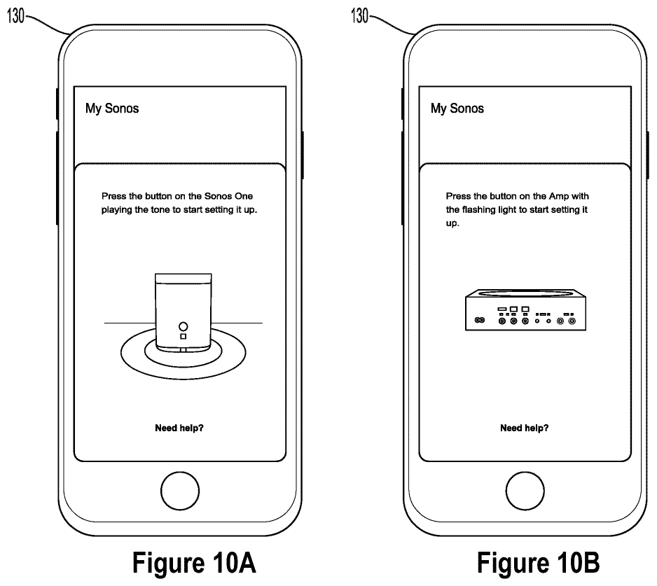

In still further implementations, the control device 130 may determine that the playback device 110 is not running firmware that supports the types of secure authentication via mutual PIN code exchange discussed above—even though the playback device 110 may possess the necessary hardware. Thus, the control device 130 may fall back to an authentication method that is supported by the playback device's firmware. For instance, the message to begin setup may cause the playback device 110 to present audible and/or visual feedback, while the control device 130 may present an indication that provides an instruction for the user to manually press a button on the playback device that is currently playing a tone and/or presenting a flashing LED light, which may cause the playback device 110 to transmit a responsive message to the control device 130 over the direct communication path. In some situations, the playback device's firmware might not support providing audible or visual feedback during authentication, and thus the control device 130 may provide an instruction for the user to manually press a button on the playback device 110 without such feedback. Examples of these types of instructions are shown in FIGS. 10A and 10B.

Although these authentication methods may be somewhat less secure than the 2-way mutual authentication discussed above, they may still provide some confirmation that the correct playback device is being selected for setup. Further, supporting these types of “legacy” authentication may extend the useable life of many older playback devices, which may only need to be set up one time using legacy authentication after a firmware update supporting secure authorization is available. Indeed, once a playback device establishes a connection to the user's WiFi network, its firmware may be updated as a subsequent step in the setup process, as discussed below. Thereafter, the updated playback device may be capable of engaging in any secure authentication method that its hardware can support (e.g., audio modulation).

d. Connect Playback Device to the Network

Once a direct communication path has been established and a connection between the control device 130 and the playback device 110 has been authenticated (e.g., mutually authenticated), the control device 130 may pass network configuration information to the playback device 110 over the direct communication path, which the playback device 110 may use to establish a connection to the user's WiFi network at block 504. The network configuration information may take various forms, including one or both of identifying information, (e.g., an SSID) and security information (e.g., a password). Additionally or alternatively, the playback device 110 may be capable of communicating with other playback devices of the user's media playback system using a proprietary mesh networking protocol, and thus the network configuration information may include information for communicating over the mesh network, such as an encryption key and a designated channel for such communications. As another example, the control device 130 may provide the playback device 110 with an identifier that corresponds to the user's media playback system, sometimes referred to as a household identifier (HHID). Various other types of network configuration information are also possible.

Some of the network configuration information discussed above may be information that is stored by the control device 130 and may be provided directly to the playback device 110. However, other types of network configuration information may not be as easily passed from the control device 130 to the playback device 110. For example, some smartphone operating systems (e.g., Android) may not provide a way for the media playback system controller application operating on the control device 130 to access SSID and password information for the user's home WiFi network, even though such information may be stored on the control device 130. Further, the media playback system controller application may not separately store such information. Accordingly, the control device 130 may prompt the user to select their SSID and enter their WiFi password the first time a user sets up a new playback device on their home WiFi network. Thereafter, if a user sets up one or more additional playback devices, the control device 130 may query the playback device 110 or another playback device that is already connected to the user's WiFi network to obtain the SSID and password information, which may then be passed to the additional playback device.

As another example, some other smartphone operating systems (e.g., iOS) may be capable of temporarily exiting the setup routine that is being executed by the media playback system controller application and providing SSID and password information to the playback device 110 directly from the operating system's memory, and then returning to the media playback system controller application to provide any remaining network configuration information (e.g., HHID). This functionality may be limited to instances wherein the direct communication path between the control device 130 and the playback device 110 has been established using a WAC connection as discussed above. When available, this type of exchange may be applied only to the first playback device that is set up on the user's home WiFi network, with the control device 130 obtaining the network configuration information from a previously set up device for each subsequent playback device that is set up.

Once the playback device 110 has successfully received the network configuration information from the control device 130, the playback device 110 may transmit an acknowledgement message to the control device 130. This acknowledgement message may cause the direct communication path between the control device 130 and the playback device 110 to be discontinued, and the devices may each transition to communicating with each other over the user's WiFi network. In some cases, such as situations where the playback device 110 is the first playback device of a new media playback system, the playback device 110 may first check that the network configuration information is correct before it sends the acknowledgement message. For example, the playback device 110 may attempt to connect to the user's WiFi network using the provided password to confirm that the user entered it correctly. If the attempted connection fails, the playback device 110 may notify the control device 130 of the failure over the direct communication path, and the control device 130 may present a prompt for the user to re-enter the password. Once the playback device 110 confirms that the password is correct, it may transmit the acknowledgement message and transition to communicating with the control device 130 over the WiFi network.

e. Assign Playback Device to a Location in the Media Playback System

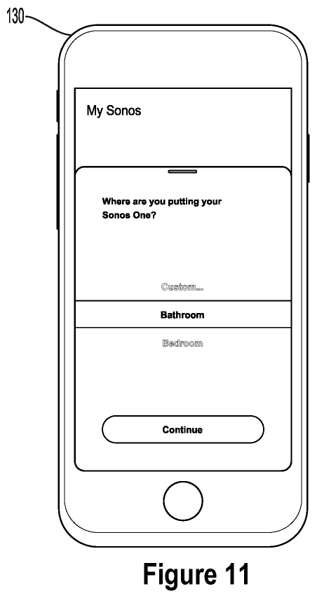

After the playback device 110 is connected to the user's WiFi network, the control device 130 may proceed with set up operations that may configure the playback device 110 for operation as a member of the user's media playback system. Accordingly, at block 505, the playback device 110 may be assigned a room name that corresponds to a location within the user's media playback system. For example, the control device 130 may present an indication prompting the user to select a room name for the playback device 110, as shown in the example of FIG. 11. In some implementations, the control device 130 may present the user with a list of commonly selected room names, such as “Kitchen,” “Bedroom,” etc. Additionally, the control device 130 may present the user with the option to input a custom room name, allowing the user to personalize their media playback system. Thereafter, whenever a new playback device is added to the user's media playback system, the user's custom-created room name(s) may be presented along with the list of more common room names.

In some media playback system arrangements, the playback device 110 may be assigned a speaker name (e.g., “Kitchen Counter”) as well as a room name (e.g., “Kitchen”), such that multiple non-bonded speakers (e.g., “Kitchen Counter” and “Fridge Top”) may have the same room name (e.g., “Kitchen”). In such arrangements, the control device 130 may present the user with a list of commonly selected speaker names and an option to input a custom speaker name, as well as a list of commonly selected room names and an option to input a custom speaker name during the setup process. The designation of the speaker name may occur before, after, or at the same time as the designation of the room name during the setup process.

The room name selected by the user on the control device 130 may be transmitted to the playback device 110 and stored in memory as a flag or similar state variable. This room name may be used by the media playback system in numerous ways. In particular, it may provide contextual information that may serve as a basis for presenting additional setup possibilities to the user. However, such additional setup possibilities might not be relevant in every case. Or, they may be relevant but not immediately important to the user. Thus, the presentation of additional setup possibilities based on the playback device's selected room name may be reserved until after the initial setup process is complete, as will be discussed in more detail below.

Additionally, if the playback device 110 is a portable playback device (e.g., a headphone device), it may be less likely to be associated with a single room in the user's media playback system. Thus, the control device 130 may skip the prompts requiring the user to assign the device a location. Alternative options for assigning a “name” to the portable playback device may replace the location-based identifier, such as an identifier that associates the portable playback device with a particular user of the media playback system. Other possibilities also exist.

f. Update the Playback Device

At block 506, after the playback device 110 has been assigned a location within the media playback system, the playback device 110 may perform a check to determine whether its software (e.g., its firmware) is up to date. If it is not, the playback device 110 may download the latest software version and perform an update. In some cases, certain updates to the playback device 110, such as firmware updates, may remain in place even if the playback device 110 is later reset to its initial “factory” settings. For instance, a factory reset is often used to erase all user-specific information from the playback device 110, such as networking credentials, media account information, and other media playback system details, before the playback device is given to a subsequent user. Nonetheless, the updated firmware may persist. Among other advantages and improvements to its functionality, this may allow the playback device 110 to utilize certain types of secure authentication (e.g., audio modulation) during setup that it was unable to support before the update.

g. Register the Playback Device

At block 507, after available updates are performed, the playback device 110 may be registered with the user's media playback system provider as a final step of the initial setup process. Registration of the playback device 110 may take various forms, including linking the playback device's serial number to the user's account with the media playback system provider. Further, as part of the registration process, a cloud-based computing system associated with the media playback system provider may transmit to the playback device 110a secure registration certificate that identifies the user's account ID and associated media playback system ID (e.g., the system's HHID). The playback device 110 may store the secure registration certificate in memory, which may thereafter provide a basis to verify communications with the playback device 110. For example, the playback device's communications with other playback devices in the user's media playback system, such as commands that the playback device 110 may issue to other playback devices, may be verified using the playback device's secure registration certificate. The same may be true of any number of local or cloud-based computing devices that may be linked in some way with the user's media playback system, including one or more control devices, media content service providers, and voice-assistant service providers, among other possibilities.

Upon successful registration, the playback device 110 may transmit a message to the control device 130, which may in turn present a message to the user indicating that the playback device 110 has been successfully added to the user's media playback system, and that setup is complete.

### V. Additional Playback Device Feature Setup

The steps for setting up the playback device 110 discussed above may represent the shortest path to (i) connect the playback device 110 to the user's WiFi network and (ii) add the playback device 110 as a member of the user's media playback system such that the user can begin enjoying audio content played back by the playback device 110. Concluding the setup process after these steps are completed may advantageously increase the likelihood that a user successfully completes initial setup of a given playback device, improving the user experience and increasing the user's confidence in their operation of the media playback system as a whole.

However, the playback device 110 might support further setup processes that enable additional playback device features, perhaps depending on the presence and capability of other playback devices in the user's system or the user's other connected accounts (e.g., a connected voice assistant provider account). These additional features may include, for example, bonding with one or more other playback devices for the synchronous playback of multi-channel audio content (e.g., left-right stereo content, 5.1 surround sound content, etc.), audio calibration that tunes the playback device's audio output according to its playback environment, the incorporation of one or more voice assistant services if the playback device 110 includes a microphone that supports voice input, and/or linking one or more of the user's media service provider accounts to the user's media playback system.

Accordingly, the control device 130 may present a prompt to begin an additional setup process of this kind when it detects that the additional feature or features may be relevant to the user's system. In some cases, this contextual information regarding the relevance of additional features for setup may be detected at the conclusion of the initial setup process discussed above. Accordingly, after the user dismisses the indication that setup of the playback device 110 is complete, the control device 130 may present the user with an option to continue with the setup of additional features. If the user dismisses the option, the control device 130 may present the user with information directing the user where to navigate if they want to proceed with the setup of additional features at a later time. For example, the control device 130 may direct the user to navigate to a settings menu.

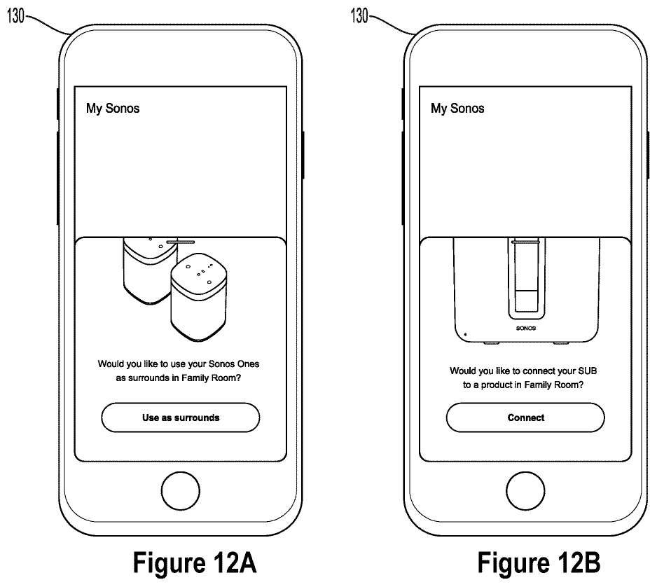

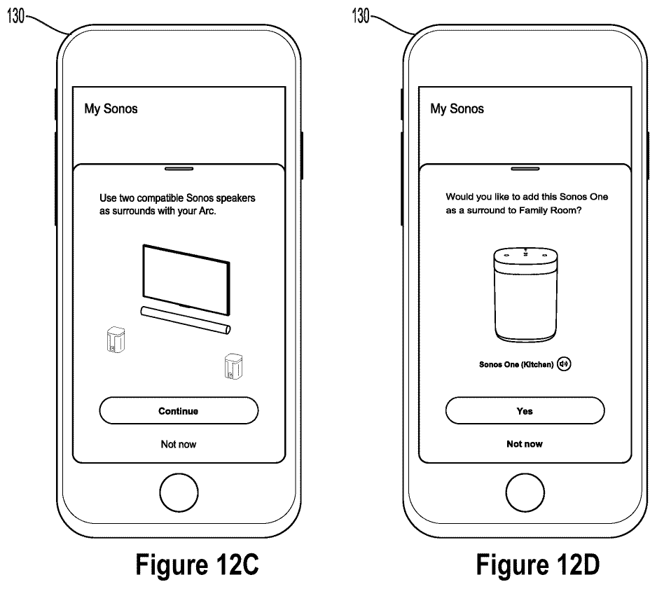

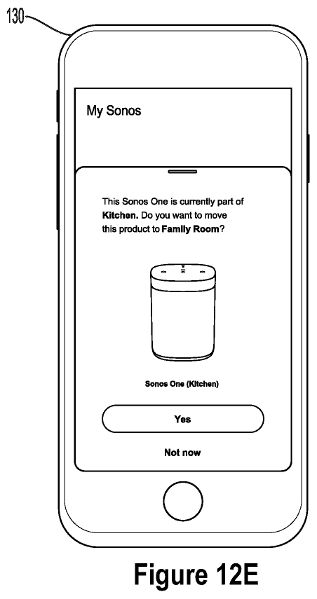

As one example of an additional setup process that may be presented to the user, the control device 130 and/or the playback device 110 may determine that two or more playback devices are assigned to the same location (e.g., the same room) in the user's media playback system, and that the two or more playback devices are compatible as members of a bonded synchrony group. Thus, the control device 130 may provide a selectable indication for the user to begin a setup process for joining the two playback devices as members of a bonded group. For example, the compatible playback devices may include two playback devices of the same model that can be bonded to play back audio content as a stereo pair. As another example, the compatible playback devices may include a soundbar or similar playback device that may form part of a home theater system, in conjunction with one or more additional playback devices that can be configured as surround speakers or a subwoofer in the home theater setup. Some example indications that may be presented by the control device 130 are shown in FIGS. 12A-12B.

In some cases, the media playback system may include additional playback devices that are candidates to join the bonded group whether or not they are assigned to the same room location. For instance, the playback device 110 and/or one or more other playback devices of the media playback system may emit a tone (e.g., a high-frequency tone that is not audible to the user) that may be detected by a microphone (e.g., a microphone 135 as discussed above) of a different playback device. Based on the detected tone (e.g., a loudness, a signal-to-noise ratio), the playback devices may be determined to be proximate to each other, perhaps in the same physical room. In these situations, the control device 130 may present the user with the option to select additional playback devices from the media playback system to join the bonded group, as shown in the examples of FIGS. 12C-12D. Further, the control device 130 may additionally prompt the user to confirm that the additional playback device(s) should be updated to reflect a new location within the media playback system. An example of this type of indication is shown in FIG. 12E.

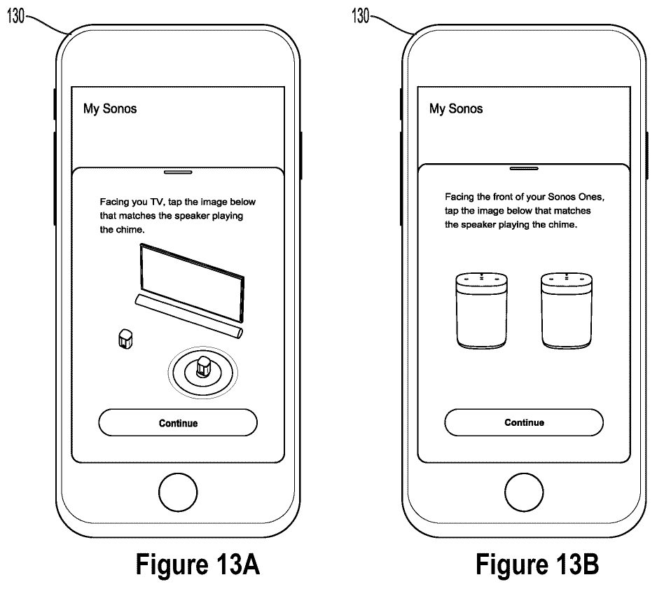

Because the synchronous playback of multi-channel channel audio content may involve a spatial component (e.g., left and right channels), and because the playback devices in the group may not be capable of determining their positions with respect to each other, the control device 130 may prompt the user to specify the relative positions of the playback devices in the group. For instance, the control device 130 may present an instruction for the user to move to a given location with respect to the playback devices in the group. In an example home theater arrangement, the user may be instructed to face their TV. In a stereo pair set up, the user may be instructed to face the front of the playback devices. One of the playback devices in the group (which may be selected at random) may play back an audible tone, and the control device 130 may instruct the user to indicate, via a selectable depiction of the playback devices provided on the control device 130, which of the playback devices is playing back the audible tone. Accordingly, the user may select a playback device in the depiction provided on the control device 130, thereby establishing the relative positions of the playback devices in the group. Some examples of these instructions are shown in FIGS. 13A-13B.

Alternatively, one or more of the playback devices in the group may be capable of determining the relative positions of the devices. For example, one or more of the playback devices may emit a tone (e.g., a high-frequency tone that is not audible to the user) that may be detected by a microphone (e.g., a microphone 135 as discussed above) of one or more of the other playback devices. In this way, relative position information for the playback devices may be determined, and the user may not need to be prompted to provide an indication of such information.

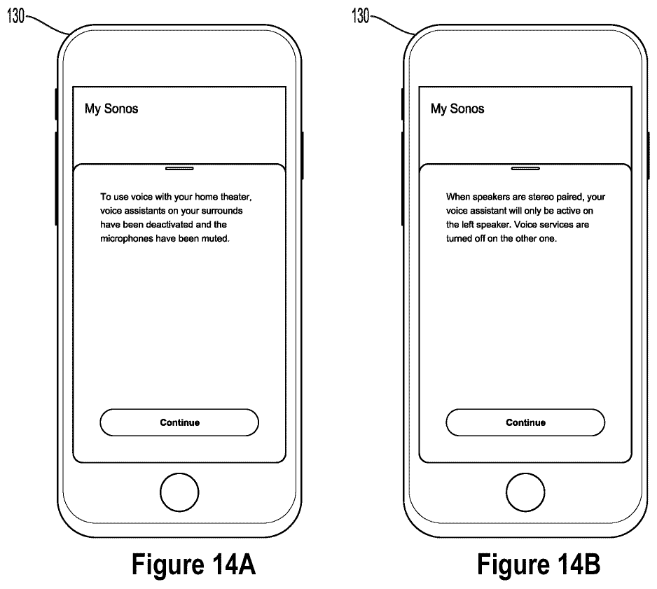

In some implementations, one or more of the playback devices that are selected for addition to the bonded group may be enabled to support a voice assistant service. In these situations, depending on the requirements of the particular voice assistant service, the control device 130 may guide the user through deactivating the voice assistant service on one or more of the member devices so that only one device in the group has an active voice assistant service. For instance, in a home theater group, voice assistant services on the surround playback devices may be deactivated so that the primary home theater playback device (e.g., the soundbar) is the only voice-capable device. If the primary home theater playback device does not support voice-capability, or if the group is only a bonded stereo pair, the control device 130 may notify the user that only one of the voice-capable playback devices (e.g., the left playback device) will include the active voice assistant service, and that the voice assistant service will be turned off on the other playback device. Some examples of these types of notifications can be seen in FIGS. 14A-14B. Other examples are also possible.

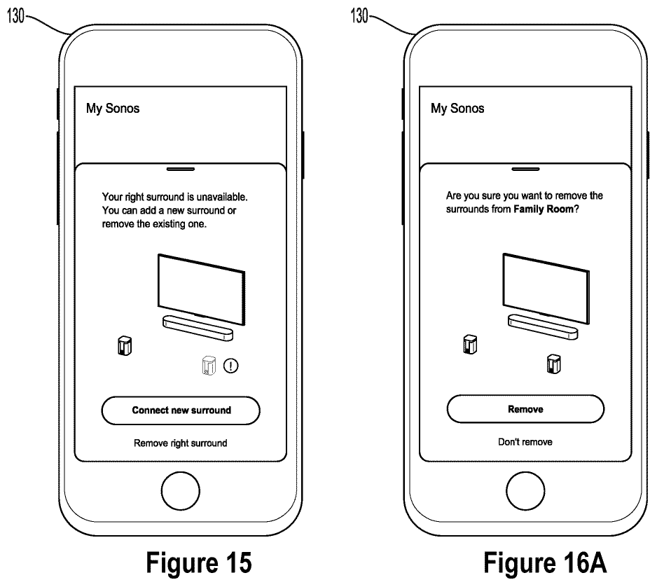

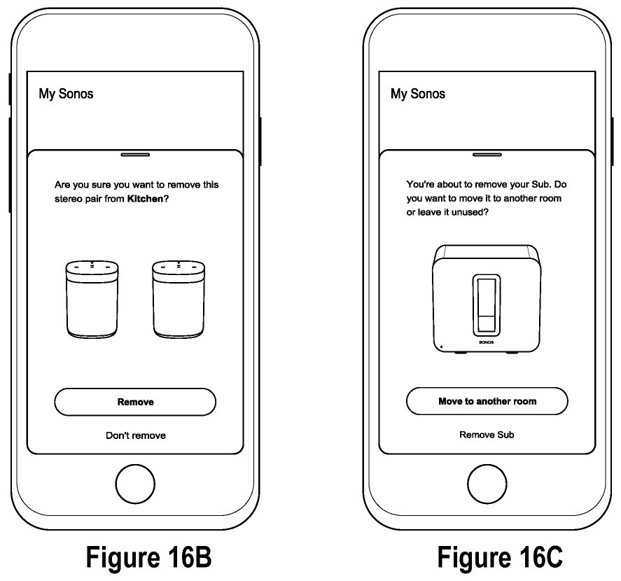

The control device 130 might also present a notification to a user if it detects a problem with one or more playback devices in the bonded group and may present the user with options to fix the issue. An example of this type of notification can be seen in FIG. 15. Further, the control device 130 may guide the user through removing one or more devices from a bonded group, upon the user's selection of a command to do so from a settings menu. Some examples of these types of instructions can be seen in FIGS. 16A-16C.

Various other sub-processes related to the bonding of playback devices in a synchrony group are also possible (e.g., subwoofer pairing, multiple subwoofers), and may be presented to the user via the control device 130 when they are determined to be relevant.

Another example of an additional setup process that may be presented to the user based on context is a calibration process. For instance, the control device 130 and/or the playback device 110 may determine that one or more devices in the user's media playback system is an NMD (e.g., an NMD 120 as discussed above) that supports capturing audio content for the purpose of calibrating a playback device to account for the spectral characteristics of its playback environment. As some embodiments, the control device 130 may be such an NMD. However, playback device calibration may represent one example of a level of setup and customization that some users are not interested in.

Accordingly, a prompt for the user to calibrate their playback device(s) using the control device 130 may not be immediately presented when such capability is detected. Rather, the control device 130 may instead determine a time when a notification regarding the calibration capability may be relevant to the user. For example, if the user activates speech enhancement on a primary home theater device, or navigates to a manual calibration menu in order to adjust the EQ of a playback device (e.g., to increase the bass response), the control device 130 may determine that the calibration capability may be of interest to the user, and may present a notification (e.g., a pop-up window) informing the user of such capability. If the user elects to proceed, the control device 130 may guide the user through the calibration process and may also prompt the user to calibrate other speakers that have similar capability. On the other hand, if the user dismissed the calibration prompt, the control device 130 may not prompt the user again. Thus, the user would need to navigate to a calibration option within a settings menu of the controller application to implement the calibration process. Additionally or alternatively, the control device 130 may present a persistent but passive notification (e.g., nested within a settings menu) that indicates that some additional setup features may be available.

Another example of an additional setup process that may be presented to the user includes enabling one or more voice assistant services on a given playback device, as mentioned in some of the examples above. As with calibration, however, voice assistant services may be a capability that some users are not interested in utilizing, and thus the control device 130 may not present it as a setup possibility whenever a voice-capable device is added to the user's system. Rather, as noted above, the control device 130 may determine a time when a notification regarding the voice-capability may be relevant to the user.

For instance, if a user is frequently using the control device 130 or the user interface on the playback device 110 to issue commands that are among the most commonly-executed by voice assistant services (e.g., volume control commands, transport control commands), the control device 130 may determine that voice capability may be relevant to the user. Accordingly, the control device 130 may present a notification informing the user that the playback device 110 supports voice assistant capability that may be used to execute the command that the user just issued. The notification may additionally prompt the user to indicate whether they would like to set up a voice assistant service now, learn more about voice assistant services, or indicate that the user is not interested in voice assistant services. If the user elects to proceed, the control device 130 may guide the user through the steps of enabling one or more voice assistant services on the playback device 110, as well as any other playback devices within the user's media playback system that are voice-capable. Further, as with calibration capability, an indication of a playback device's voice-capability may otherwise be presented as a passive notification within a settings menu. Various other possibilities also exist.

Yet another example of an additional setup process that may be presented to the user involves linking one or more of the user's media service provider accounts to the user's media playback system. In many cases, the media playback system controller application and the playback devices of the user's media playback system may be capable of playing back audio content from various media sources at the conclusion of initial setup, such as one or more media services provided by the media playback system provider (e.g., Sonos Radio). Nonetheless, the linking of media service provider accounts to a user's media playback system may represent a more widely utilized setup process than playback device calibration or voice assistant services. Consequently, although a notification for the user to begin linking media service provider accounts may not be presented as a part of initial playback device setup, so as not to overburden the user during this process, the control device 130 may present a more active notification to the user informing them of this setup option. For example, the home screen of the media playback system controller application may present a persistent notification dot or similar identifier to draw the user's attention. Similarly, if the user browses for media items from a free or default service, or stored on the control device 130 or a local NAS device, the control device 130 may present a notification (e.g., a pop-up window) prompting the user to link one or more of their media service provider accounts.

Numerous other playback device features and media playback system features are also possible, with various contextual cues that the control device 130 and/or the playback device 110 may use to determine when a notification to set up such features may be relevant to a user.

Some of the figures discussed herein include one or more operations, functions, or actions as illustrated by one or more of operational blocks. Although the blocks are illustrated in a given order, some of the blocks may also be performed in parallel, and/or in a different order than those described herein. Also, the various blocks may be combined into fewer blocks, divided into additional blocks, and/or removed based upon the desired implementation.

In addition, for the flowcharts shown in the figures and other processes and methods disclosed herein, the diagrams show functionality and operation of one possible implementation of present embodiments. In this regard, each block may represent a module, a segment, or a portion of program code, which includes one or more instructions executable by one or more processors for implementing logical functions or blocks in the process.

The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long-term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In addition, for the processes and methods disclosed herein, each block may represent circuitry and/or machinery that is wired or arranged to perform the specific functions in the process.

### VI. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A computing device comprising:
at least one processor;
at least one wireless network interface;
at least one non-transitory computer-readable medium; and
program instructions stored on the at least one non-transitory computer-readable medium that, when executed by the at least one processor, cause the computing device to:
receive, via the at least one wireless network interface, a set of one or more messages from a playback device collectively indicating (i) that the playback device is available for setup and (ii) network connection capability of the playback device;
establish a direct communication path with the playback device;
receive, outside the direct communication path, authentication information from the playback device;
after receiving, outside the direct communication path, the authentication information from the playback device, (i) receive, via the direct communication path, the authentication information from the playback device and (ii) transmit, via the direct communication path, the authentication information to the playback device;
after (i) receiving and (ii) transmitting the authentication information via the direct communication path, transmit, to the playback device over the direct communication path, network configuration parameters for connecting to a secure wireless network;
after transmitting the network configuration parameters for connecting to a secure wireless network, detect an indication that the playback device has successfully received the network configuration parameters; and
after detecting the indication that the playback device has successfully received the network configuration parameters, transition from communicating with the playback device over the direct communication path to communicating with the playback device over the secure wireless network.

2. The computing device of claim 1, wherein the at least one wireless network interface comprises at least two wireless network interfaces, and wherein the program instructions that, when executed by the at least one processor, cause the computing device to receive the set of one or more messages comprise program instructions that, when executed by the at least one processor, cause the computing device to receive the set of one or more messages via each of the at least two wireless network interfaces.

3. The computing device of claim 2, wherein the at least two wireless network interfaces comprise (i) a WiFi interface and (ii) a Bluetooth interface.

4. The computing device of claim 2, wherein the network connection capability of the playback device comprises an indication of each of at least two wireless network interfaces of the playback device over which the set of one or more messages is transmitted to the computing device.

5. The computing device of claim 1, wherein the authentication information comprises a PIN code generated by the playback device based on establishing the direct communication path with the computing device.

6. The computing device of claim 5, wherein the program instructions that, when executed by the at least one processor, cause the computing device to receive, outside the direct communication path, the PIN code from the playback device comprise program instructions that, when executed by the at least one processor, cause the computing device to receive the PIN code from the playback device via near-field communications (NFC).

7. The computing device of claim 5, wherein the program instructions that, when executed by the at least one processor, cause the computing device to receive, outside the direct communication path, the PIN code from the playback device comprise program instructions that, when executed by the at least one processor, cause the computing device to receive the PIN code from the playback device via ultrasonic audio modulation.

8. The computing device of claim 1, wherein the playback device is a first playback device, the computing device further comprising program instructions stored on the at least one non-transitory computer-readable medium that, when executed by the at least one processor, cause the computing device to:
receive, from the first playback device, an indication that a second playback device is located near the first playback device; and
after receiving the indication, transmit, to the first playback device, a command to join the second playback device as a member of a bonded playback device group and thereby cause the first playback device to join the second playback device as the member of the bonded playback device group.

9. The computing device of claim 1, wherein the program instructions that, when executed by the at least one processor, cause the computing device to detect the indication that the playback device has successfully received the network configuration parameters comprise program instructions that, when executed by the at least one processor, cause the computing device to receive, from the playback device via the direct communication path, a message indicating that the playback device has successfully received the network configuration parameters.

10. A non-transitory computer-readable medium, wherein the non-transitory computer-readable medium is provisioned with program instructions that, when executed by at least one processor, cause a computing device to:
receive, via at least one wireless network interface of the computing device, a set of one or more messages from a playback device collectively indicating (i) that the playback device is available for setup and (ii) network connection capability of the playback device;
establish a direct communication path with the playback device;
receive, outside the direct communication path, authentication information from the playback device;
after receiving, outside the direct communication path, the authentication information from the playback device, (i) receive, via the direct communication path, the authentication information from the playback device and (ii) transmit, via the direct communication path, the authentication information to the playback device;
after (i) receiving and (ii) transmitting the authentication information via the direct communication path, transmit, to the playback device over the direct communication path, network configuration parameters for connecting to a secure wireless network;
after transmitting the network configuration parameters for connecting to a secure wireless network, detect an indication that the playback device has successfully received the network configuration parameters; and
after detecting the indication that the playback device has successfully received the network configuration parameters, transition from communicating with the playback device over the direct communication path to communicating with the playback device over the secure wireless network.

11. The non-transitory computer-readable medium of claim 10, wherein the at least one wireless network interface comprises at least two wireless network interfaces, and wherein the program instructions that, when executed by at least one processor, cause the computing device to receive the set of one or more messages comprise program instructions that, when executed by at least one processor, cause the computing device to receive the set of one or more messages via each of the at least two wireless network interfaces.

12. A method implemented by a computing device, the method comprising:
receiving, via at least one wireless network interface of the computing device, a set of one or more messages from a playback device collectively indicating (i) that the playback device is available for setup and (ii) network connection capability of the playback device;
establishing a direct communication path with the playback device;
receiving, outside the direct communication path, authentication information from the playback device;
after receiving, outside the direct communication path, the authentication information from the playback device, (i) receiving, via the direct communication path, the authentication information from the playback device and (ii) transmitting, via the direct communication path, the authentication information to the playback device;
after (i) receiving and (ii) transmitting the authentication information via the direct communication path, transmitting, to the playback device over the direct communication path, network configuration parameters for connecting to a secure wireless network;
after transmitting the network configuration parameters for connecting to a secure wireless network, detecting an indication that the playback device has successfully received the network configuration parameters; and
after detecting the indication that the playback device has successfully received the network configuration parameters, transitioning from communicating with the playback device over the direct communication path to communicating with the playback device over the secure wireless network.

13. The method of claim 12, wherein the at least one wireless network interface comprises at least two wireless network interfaces, and wherein causing the computing device to receive the set of one or more messages comprises:
receiving the set of one or more messages via each of the at least two wireless network interfaces.

14. The method of claim 13, wherein the at least two wireless network interfaces comprise (i) a WiFi interface and (ii) a Bluetooth interface.

15. The method of claim 13, wherein the network connection capability of the playback device comprises an indication of each of at least two wireless network interfaces of the playback device over which the set of one or more messages is transmitted to the computing device.

16. The method of claim 12, wherein the authentication information comprises a PIN code generated by the playback device based on establishing the direct communication path with the computing device.

17. The method of claim 16, wherein receiving, outside the direct communication path, the PIN code from the playback device comprises:
receiving the PIN code from the playback device via near-field communications (NFC).

18. The method of claim 16, wherein receiving, outside the direct communication path, the PIN code from the playback device comprises:
receiving the PIN code from the playback device via ultrasonic audio modulation.

19. The method of claim 12, wherein the playback device is a first playback device, the method further comprising:
receiving, from the first playback device, an indication that a second playback device is located near the first playback device; and
after receiving the indication, transmitting, to the first playback device, a command to join the second playback device as a member of a bonded playback device group and thereby cause the first playback device to join the second playback device as the member of the bonded playback device group.

20. The method of claim 12, wherein detecting the indication that the playback device has successfully received the network configuration parameters comprises:
receiving, from the playback device via the direct communication path, a message indicating that the playback device has successfully received the network configuration parameters.
